(19) United States
(12) Patent Application Publication
(10) Pub. No.: US 2008/0229956 A1
(43) Pub. Date: Sep. 25, 2008

(54) ON-PRESS DEVELOPABLE LITHOGRAPHIC PRINTING PLATE PRECURSOR

(75) Inventors: Norio AOSHIMA, Shizuoka (JP); Katsumi ARAKI, Shizuoka (JP)

Correspondence Address: SUGHRUE-265550, 2100 PENNSYLVANIA AVE. NW, WASHINGTON, DC, 20037-3213, US

(73) Assignee: FUJIFILM CORPORATION, Tokyo (JP)

(21) Appl. No.: 12/051,874

(22) Filed: Mar. 20, 2008

(30) Foreign Application Priority Data
Mar. 20, 2007 (JP) 2007-072267

(51) Int. Cl. B41M 5/00

(52) U.S. Cl. 101/463.1

(57) ABSTRACT

A lithographic printing plate precursor, which is on-press developable by supplying an oily ink and an aqueous component, includes an image forming layer that has, in an exposed area thereof at 25° C., a water content change rate of 2.0 mass % or less when relative humidity is changed from 30% to 50%.

### BACKGROUND OF THE INVENTION

1. Field of the Invention

The present invention relates to a lithographic printing plate precursor. More specifically, it relates to an on-press developable lithographic printing plate precursor capable of undergoing a so-called direct plate-making, which can be directly plate-made by scanning laser beam based on digital signals of, for example, a computer.

2. Description of the Related Art

For manufacturing a lithographic printing plate, it has been a common practice to employ a system wherein a lithographic printing plate precursor employed as an intermediate material is exposed via a lith film. With the recent rapid progress in digitalization in the field of printing, however, the lithographic plate-making process is now changing into the computer-to-plate (CTP) system whereby digital data having been input and edited in a computer is directly output. To further streamline the plate-making process, plate precursors that can be employed in printing as such after exposure without requiring development have been created.

As one of the methods realizing processless plate-making, there is a method called on-press development in which an exposed printing plate precursor is fixed on the plate cylinder of a printing press, and a fountain solution and an ink are supplied thereto while rotating the cylinder to thereby remove an non-required image forming layer. That is, this method comprises exposing a lithographic printing plate precursor, mounting it as such on a press thus completing the development on an ordinary printing line. It is required that a lithographic printing plate precursor suitable for the on-press development has an image forming layer that is soluble in a fountain solution or an ink solvent and also has daylight handling properties suitable for on-press development to be conducted in a daylight room.

For example, Japanese Patent No. 2938397 discloses a lithographic printing plate precursor having a photosensitive layer, in which microparticles made of a thermoplastic hydrophobic polymer are dispersed in a hydrophilic binder resin, located on a hydrophilic support. In Japanese Patent No. 2938397, it is reported on-press development can be conducted by laser-exposing the lithographic printing plate precursor, thus thermally binding together the thermoplastic hydrophobic polymer microparticles to thereby form an image, mounting the plate on the cylinder of a printing press and then removing an unexposed area with a fountain solution and/or an ink. Because of having a sensitive region within the infrared region, this lithographic printing plate precursor has excellent daylight handling properties.

Also, JP-A-9-127683, JP-A-9-123387, JP-A-9-123388, JP-A-9-131850, and WO 99/10186 propose to make a printing plate by on-press development after thermally binding thermoplastic microparticles.

JP-A-2001-293971 discloses that a lithographic printing plate precursor having an image recording layer which contains at least any of thermoplastic polymer microparticles, microparticles made of a polymer having a heat-reactive group and microcapsules containing a compound having a heat-reactive group encapsulated therein has an excellent on-press developability, a high sensitivity and a high printing durability.

JP-A-2002-29162 discloses that an on-press developable heat-sensitive lithographic printing plate precursor having an image recording layer which contains microcapsules containing a compound having a vinyloxy group encapsulated therein, a hydrophilic resin and an acid precursor establishes a favorable printing durability.

Further, JP-A-2002-46361 discloses that an on-press developable heat-sensitive lithographic printing plate precursor having an image recording layer which contains microcapsules containing a compound having an epoxy group encapsulated therein, a hydrophilic resin and an acid precursor establishes a favorable printing durability.

Furthermore, JP-A-2002-137562 discloses that an on-press developable heat-sensitive lithographic printing plate precursor having an image recording layer which contains microcapsules containing a compound having a radical-polymerizable group encapsulated therein, a hydrophilic resin and a heat-sensitive polymerization initiator establishes a favorable printing durability.

Moreover, JP-A-2004-299264 discloses a lithographic printing plate precursor having a light-sensitive layer comprising microparticles made of a lipophilic polymer dispersed in a hydrophilic polymer matrix wherein development is conducted by converting irradiated light into heat by a light absorbing agent contained in the light-sensitive layer, causing foaming or thermal fusion of the lipophilic polymer by the heat thus generated, and thus changing the light-sensitive layer from hydrophilic to ink-compatible.

### SUMMARY OF THE INVENTION

From practical viewpoint, these existing techniques are still insufficient in achieving both of a high on-press developability and a high printing durability. An object of the present invention is to provide a on-press developable lithographic printing plate precursor which enables image recording by laser exposure and is excellent in on-press developability and printing durability.

Based on the assumption that lowering in printing durability and dependency on dampening solution species of an on-press developable lithographic printing plate precursor are caused by the fact that since the image forming layer is highly water permeable for achieving on-press developability, water is liable to penetrate into an image area under printing and thus the image area becomes fragile, the present inventor examined the water absorptivity of the exposed image forming layer, thereby completing the invention. The invention is as follows.

<1> A lithographic printing plate precursor, which is on-press developable by supplying an oily ink and an aqueous component, comprising:

an image forming layer that has, in an exposed area thereof at 25° C., a water content change rate of 2.0 mass % or less when relative humidity is changed from 30% to 50%.

<2> The lithographic printing plate precursor as described in <1>, wherein

the water content change rate is from 0.5 to 1.5 mass %.

<3> The lithographic printing plate precursor as described in <1>, wherein

the image forming layer comprises a binder resin having a functional group which becomes hydrophobic upon exposure,

<4> The lithographic printing plate precursor as described in <3>, wherein

the binder resin is contained in an amount of from 5 to 30 mass % based on a total solid content of the image forming layer.

<5> The lithographic printing plate precursor as described in <1>, wherein

the image forming layer comprises a polymerizable compound having a salt structure.

<6> The lithographic printing plate precursor as described in <5>, wherein

the polymerizable compound is contained in an amount of from 10 to 80 mass % based on a total solid content of the image forming layer.

<7> The lithographic printing plate precursor as described in <5>, wherein

the polymerizable compound is an amine salt of a sulfonic acid compound.

<8> The lithographic printing plate precursor as described in <1>, wherein

the image forming layer comprises a particle which is dispersible in a polar solvent.

<9> The lithographic printing plate precursor as described in <8>, wherein

the particle dispersible in a polar solvent is a particle of a copolymer containing acrylonitrile.

### DETAILED DESCRIPTION OF THE INVENTION

### [Water Content Change Rate]

The lithographic printing plate precursor of the invention is on-press developable and has an image forming layer wherein the water content change rate accompanying an increase in relative humidity from 30% to 50% at 25° C. is 2.0 mass % or less. By controlling the water content change rate in this manner, the printing durability can be improved and the dependency of printing durability on dampening solution can be relieved. Thus, problems relating to printing durability in the existing on-press developable printing plates can be effectively solved.

In the invention, the water content change rate indicates the compatibility of an exposed area of the image forming layer with water. Namely, it can be considered as showing the fountain solution-permeability of an image area after plate-making.

In the invention, the water content change rate W(r) is determined by the following method.

When the storage condition of a lithographic printing plate precursor is changed from a certain humidity to a higher humidity, the mass of the lithographic printing plate precursor generally increases. This change in mass, which is caused by water absorption (moisture absorption) by the lithographic printing plate precursor, is roughly equals to the amount of water absorbed by the image forming layer. In the invention, therefore, a change in the amount of water absorbed by an exposed lithographic printing plate precursor is measured and the value determined in accordance with the following formula is defined as the water content change rate W(r) of an exposed area of the image forming layer.

W(r)={W(50)−W(30)}×100/{S×W(i)}

In the above formula, the symbols respectively have the following meanings.

W(30): The mass (g) measured by a precision balance of an exposed lithographic printing plate precursor having been stored in an environment at 25° C. and 30% relative humidity for 60 min.

W(50): The mass (g) measured by a precision balance of the same lithographic printing plate precursor as used in measuring W(30) having been stored in an environment at 25° C. and 50% relative humidity for 60 min.

S: The area (m²) of the lithographic printing plate precursor used in measuring W(30) and W(50). It is preferably 0.1 m² or more.

W(i): The coating amount (g/m²) of the image forming layer formed on a support. It is calculated from a mass change caused by removing the image forming layer formed on a support with the use of an organic solvent or the like.

Exposure is conducted at an exposure dose of 300 mJ/cm².

By controlling the water content change rate W(r) as described above to 2.0 mass % or less, a favorable printing durability can be obtained. It is more preferable that the water content change rate is from 0.5 to 1.5 mass %. When the water content change rate exceeds 2.0 mass %, a fountain solution permeates the image forming layer (image area) in an exposed area and thus the printing durability is deteriorated. It is preferable that the water content change rate is 0.5 mass % or more, since the an unexposed area shows a preferred fountain solution-permeability and the on-press developability is improved in this case.

As a specific embodiment for achieving the water content of the exposed area of the image forming layer, it is preferable to add a material, which undergoes a polarity change from hydrophilic nature into hydrophobic nature at the exposure, to the image forming layer. As such a compound, it is preferable to use a binder resin having a hydrophilic and heat-decomposable functional group which becomes hydrophobic upon exposure, such as a sulfonate group or an ammonium group, or a polymerizable having a salt structure. It is also effective to promote the polymerization reaction at the exposure. More specifically speaking, it is preferable to add a binder resin having a crosslinking group, a polyfunctional polymerizable compound, an oxygen barrier material or the like. As a matter of course, the water content change rate can be regulated within the range as defined in the invention by making a component contained in the image forming layer hydrophobic or adding a hydrophobic compound and a hydrophilic compound at a controlled ratio. Among all, it is preferable to add a polarity-changing material or a polymerization reaction-promoting material, since the on-press developability is scarcely affected thereby.

[Image Forming layer]

Next, the image forming layer of the invention will be described in greater detail.

It is preferable that the image forming layer of the invention is the type which contains a polymerizable compound having a salt structure or a binder resin and an infrared absorbing agent and a polymerization initiator and is polymerized and hardened by infrared laser irradiation. The image forming layer of the invention can be removed by a printing ink and/or a fountain solution.

### <Polymerizable Compound Having Salt Structure>

It is preferable that the image forming layer of the invention contains a polymerizable compound having a salt structure. In the polymerizable compound having a salt structure to be used in the invention, a polymerizable group is located in the vicinity of a hydrophilic ionic group. When the polymerizable group undergoes polymerization upon exposure, the hydrophilic ionic group is physically blocked and the hydrophilicity is lowered, i.e., becoming hydrophobic. Although the salt structure comprises any combination of a cationic group with an anionic group, a combination of an amine salt of a sulfonic acid compound is preferred.

The polymerizable group as described above is an ethylenically unsaturated group capable of undergoing addition polymerization and a terminal ethylenically unsaturated group is preferred.

An amine salt of a sulfonic acid compound having a polymerizable group which is usable in the invention is a salt of a compound having at least one sulfonate group and a compound having at least one amino group. It may be either an intramolecular salt or a salt composed of two or more molecules. Such compounds are widely known in the field of organic chemistry and any of them may be used in the invention without restriction.

Examples of the amine salt of a sulfonic acid compound appropriately usable in the invention include those which are obtained by combining a sulfonic acid compound with an amine compound described in Aldrich Structure Index 1996-1997 Edition, 1996, Aldrich Chemical Company Inc. wherein at least one polymerizable group has been introduced into one or both of the sulfonic acid compound and the amine compound.

To improve the hydrophobication effect, it is preferable that the amine salt of a sulfonic acid compound has two or more amine salt structures per molecule.

Next, specific examples of the amine salt of a sulfonic acid compound appropriately usable in the invention will be presented, though the invention is not restricted thereto.

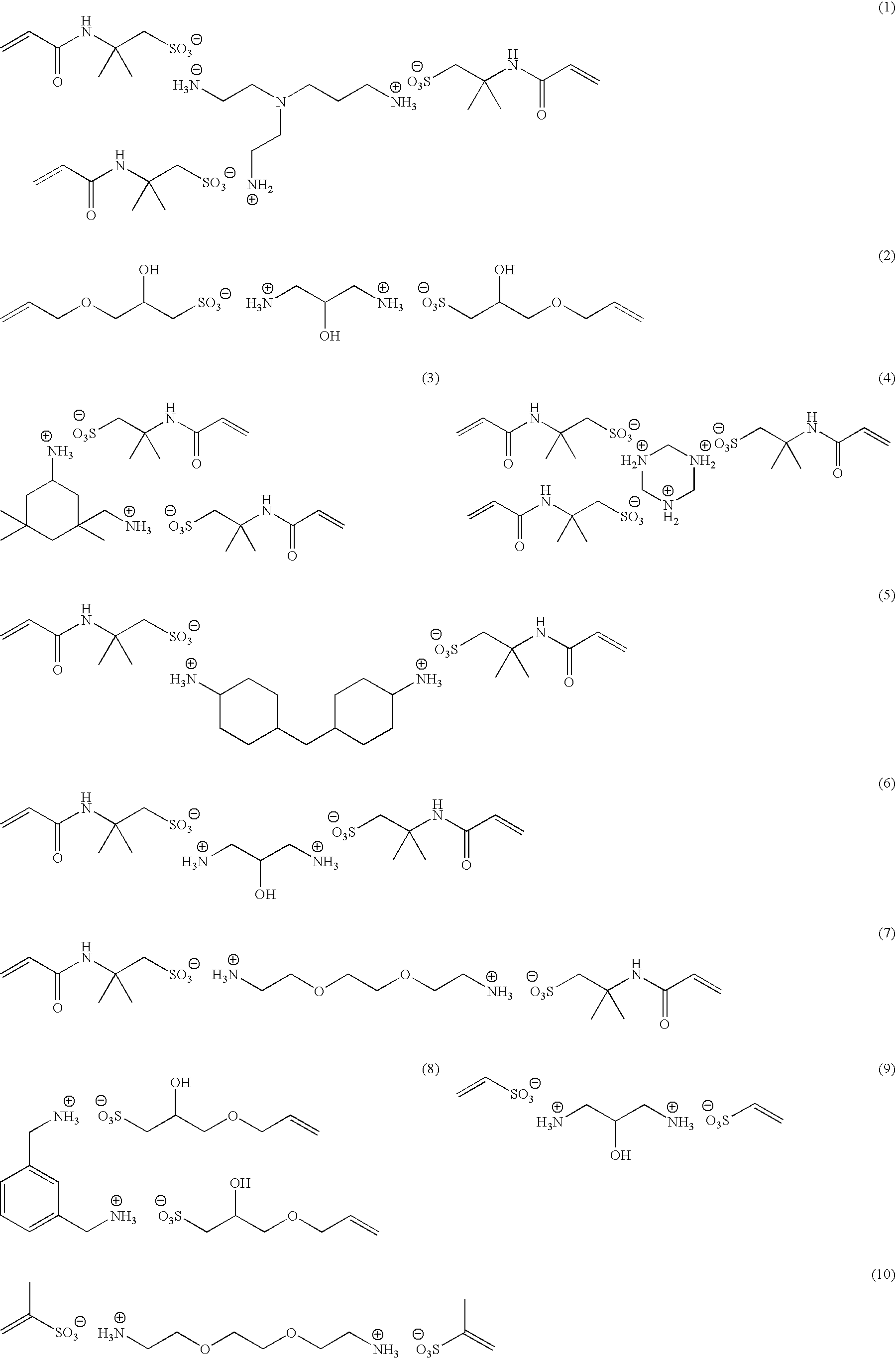

The polymerizable compound having a salt structure is used in an amount of preferably from 10 to 80 mass %, more preferably from 15 to 70 mass % and particularly preferably from 20 to 60 mass % based on the total solid content of the image forming layer. Either one of these compounds or a combination of two or more thereof may be used.

### <Other Polymerizable Compound>

In the image forming layer of the invention, it is possible to use a compound having an ethylenically unsaturated group capable of undergoing addition polymerization as a salt structure-free compound to be combined with the polymerizable compound having a salt structure as described above or a binder resin having a group capable of undergoing a polarity change as will be described hereinafter. Such a compound can be arbitrarily selected among compounds having at least one, preferably two or more, ethylenically unsaturated double bond groups at the photopolymerizable ends. These polymerizable compounds have chemical forms of, e.g., a monomer or a prepolymer, i.e., a dimer, a trimer or an oligomer, and a mixture and a copolymer of them. Examples of monomers and copolymers of them include unsaturated carboxylic acids (e.g., acrylic acid, methacrylic acid, itaconic acid, crotonic acid, isocrotonic acid, maleic acid, etc.), and esters thereof with polyhydric alcohols and amides of these unsaturated carboxylic acids with aliphatic polyvalent amine compounds.

Specific examples of the monomers that are esters of aliphatic polyhydric alcohol compounds with unsaturated carboxylic acids include acrylic esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol pentaacrylate, dipentaerythritol hexaacrylate, sorbitol triacrylate, sorbitol tetraacrylate, sorbitol pentaacrylate, sorbitol hexaacrylate, tri(acryloyloxyethyl)isocyanurate, polyester acrylate oligomer, and so on.

As methacrylic esters, examples thereof include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, dipentaerythritol pentamethacrylate, sorbitol trimethacrylate, sorbitol tetramethacrylate, bis[p-(3-methacryloxy-2-hydroxypropoxy)phenyl]dimethylmethane, bis[p-(methacryloxyethoxy)phenyl]-dimethylmethane, and so on.

As itaconic esters, examples thereof include ethylene glycol diitaconate, propylene glycol diitaconate, 1,3-butanediol diitaconate, 1,4-butanediol diitaconate, tetramethylene glycol diitaconate, pentaerythritol diitaconate, sorbitol tetraitaconate, and so on.

As crotonic esters, examples thereof include ethylene glycol dicrotonate, tetramethylene glycol dicrotonate, pentaerythritol dicrotonate, sorbitol tetradicrotonate, and so on.

As isocrotonic esters, examples thereof include ethylene glycol diisocrotonate, pentaerythritol diisocrotonate, sorbitol tetraisocrotonate, and so on.

As maleic esters, examples thereof include ethylene glycol dimaleate, triethylene glycol dimaleate, pentaerythritol dimaleate, sorbitol tetramaleate, and so on.

Moreover, mixtures of the above-described ester monomers may be cited.

Further, specific examples of the monomers that are amides of aliphatic polyvalent amine compounds with unsaturated carboxylic acids include methylenebis-acrylamide, methylenebis-methacrylamide, 1,6hexamethylenebis-acrylamide, 1,6-hexamethylenebis-methacrylamide, diethylenetriaminetris-acrylamide, xylylenebis-acrylamide, xylylenebis-methacrylamide, and so on.

As other examples, there can be enumerated a vinyl urethane compound containing two or more polymerizable vinyl groups per molecule which is obtained by adding an ester of an unsaturated carboxylic acid with an aliphatic polyhydric alcohol compound as described above or a vinyl monomer having a hydroxyl group represented by the following formula (1) or (2) to a polyisocyanate compound having two or more isocyanate groups per molecule such as hexamethylene diisocyanate.

CH₂═C(Q¹)COOCH₂CH(Q²)OH (1)

In the above formula, Q¹ and Q² independently represent each H or CH₃.

(CH₂═C(Q¹)COOCH₂)ₐC(Q²)_{b}(Q³) (2)

In the above formula, Q¹ and Q² independently represent each H or CH₃ and Q³ represents —CH₂OH. a and c independently represent each an integer of from 1 to 3 and b is 0, 1 or 2, provided that a+b+c is 4.

Further, there can be enumerated polyfunctional acrylates and methacrylates such as urethane acrylates disclosed in JP-A-51-37193, polyester acrylates disclosed in JP-A-48-64183, JP-B-49-43191 and JP-B-52-30490, epoxy acrylates obtained by reacting an epoxy resin with (meth)acrylic acid, etc. Furthermore, it is possible to use photo-curable monomers and oligomers presented in Nippon Setchaku Kyokai-shi, Vol. 20, No. 7, p. 300 to 308 (1984).

Specific examples thereof include NK Oligo U-4HA, U-4H, U-6HA, U-108A, U-1084A, U-200AX, U-122A, U-340A, U-324A and UA-100 (manufactured by Shin-Nakamura Kagaku K.K.), UA-306H, AI-600, UA-101T, UA-101I, UA-306T and UA-306I (manufactured by Kyoeisha Chemical Co., Ltd.), ARTRESIN UN-9200A, UN-3320HA, UN-3320HB, UN-3320HC, SH-380G, SH-500 and SH-9832 (manufactured by Negami Kogyo K.K.), and so on.

It is preferable to use the polymerizable compound in an amount of from 5 to 90 mass %, more preferably from 10 to 80 mass %, based on the total components of the image forming layer.

The polymerizable cound may be used as a dispersion which is encapsulated in a microcapsule or a microgel. By formulating it into a dispersion, it becomes possible to relieve the stickiness on the image forming layer surface and overcome the problems of the adhesion in board lamination and fingerprint stain, thereby improving the handling properties. Moreover, the physical strength of the image forming layer can be lowered, which contributes to the maintenance of favorable on-press developability.

For the enmicrocapsulation or microgelling of the polymerizable compound as described above, a publicly known method can be applied. The term “microcapsule” as used herein means a core-shell type particle containing the polymerizable compound in the core, while the term “microgel” as used herein means one not showing any definite phase separation structure.

Useful encapsulation techniques include, but are not limited to, the methods using coacervation as disclosed in U.S. Pat. Nos. 2,800,457 and 2,800,458, the methods using interfacial polymerization as disclosed in U.S. Pat. No. 3,287,154, JP-B-38-19574 and JP-B-42-446, the methods using polymer precipitation as disclosed in U.S. Pat. Nos. 3,418,250 and 3,660,304, the method using isocyanate/polyol wall materials as disclosed in U.S. Pat. No. 3,796,669, the method using isocyanate wall materials as disclosed in U.S. Pat. No. 3,914,511, the methods using urea/formaldehyde or urea formaldehyde/resorcinol wall materials as disclosed in U.S. Pat. Nos. 4,001,140, 4,087,376, and 4,089,802, the method using wall materials such as melamine-formaldehyde resins, hydroxycellulose, etc. as disclosed in U.S. Pat. No. 4,025,445, the in situ polymerization methods as disclosed in JP-B-36-9163 and JP-B-51-9079, the spray drying methods as disclosed in British Patent 930422 and U.S. Pat. No. 3,111,407, and the melting/dispersing/cooling methods as disclosed in British Patents 952807 and 967074.

The microcapsule wall preferably usable in the invention has a three-dimensional crosslinked structure and swells with a solvent. From this viewpoint, preferable examples of the wall material include polyurea, polyurethane, polyester, polycarbonate, polyamide and mixtures thereof. Polyurea and polyurethane are particularly preferred. It is possible to introduce a compound having a heat-reactive functional group into the microcapsule wall.

The average particle size of the microcapsules is preferably 0.01 to 3.0 μm, more preferably 0.05 to 2.0 μm and particularly preferably 0.10 to 1.0 μm. Within this range, a favorable resolution and aging stability can be obtained.

These microcapsules may or may not be fused together by heat. In summary, it is enough that some component of the contents enclosed in the microcapsules oozing out on the capsule surface or outside the microcapsules or entering into the microcapsule wall undergoes a chemical reaction due to heat. It may react with a hydrophilic resin or a low-molecular compound having been added. It is also possible that two or more kinds of microcapsules having different functional groups, which would undergo a chemical reaction due to heat, react with each other. That is to say, it is preferable from the viewpoint of image formation but not essentially required that microcapsules are fused together by heat.

The content of the microcapsules in the image forming layer is preferably 50 mass % or more, still preferably 70 to 98 mass %, on solid basis based on the solid content of the image forming layer. Within this range, the image forming layer ensures good image formation and a high printing durability.

In the case of adding microcapsules to the image forming layer of the invention, it is possible to add a solvent, in which the contents are soluble and with which the wall material swells, to the dispersion medium for the microcapsules. This solvent promotes the diffusion of the compound having a heat reactive group enclosed in the microcapsules to the outside thereof. The solvent can be easily selected from among a number of commercially available solvents, though it depends on the microcapsule dispersion medium, the microcapsule wall material, the wall thickness and the contents. In the case of water-dispersible microcapsules having a wall made of crosslinked polyurea or polyurethane, for example, alcohols, ethers, acetals, esters, ketones, polyhydricl alcohols, amides, amines, fatty acids, etc. are preferred.

Specific examples of the compound include, but are not limited to, methanol, ethanol, ter-butanol, n-propanol, tetrahydrofuran, methyl lactate, ethyl lactate, methyl ethyl ketone, propylene glycol monomethyl ether, ethylene glycol diethyl ether, ethylene glycol monomethyl ether, γ-butyl lactone, N,N-dimethylformamide, N,N-dimethylacetamide, and so on. It is also possible to use two or more kinds of these solvents. Use can be also made of a solvent which is not soluble in the microcapsule dispersion but becomes soluble by adding a solvent as described above.

The amount of the solvent to be added depends on the combination of the materials. It is usually effective to add from 5 to 95 mass % of the solvent based on the coating solution, preferably from 10 to 90 mass % and more preferably from 15 to 85 mass %.

### <Infrared Absorbing Agent>

An infrared absorbing agent is a substance having the maximum absorption wavelength within the near infrared to infrared range. More specifically speaking, it is a substance having the maximum absorption wavelength in a range of 760 to 1200 nm. As examples of such a substance, various pigments and dyes may be cited. As the pigment to be used in the invention, use can be made of commercially available pigments and pigments described in Color Index (C.I.) Binran, Saishin Ganryo Binran (ed. by Nippon Ganryo Gijutsu Kyokai, 1977), Saishin Ganryo Oyo Gijutsu (CMC Shuppan, 1986) and Insatsu Inki Gijutsu (CMC Shuppan, 1984). Concerning the types of the pigments, use can be made of black pigments, yellow pigments, orange pigments, brown pigments, red pigments, purple pigments, blue pigments, green pigments, fluorescent pigments, polymer-binding pigments, etc. More specifically speaking, use can be made of insoluble azo pigments, azo lake pigments, condensed azo pigments, chelate azo pigments, phthalocyanine-type pigments, anthraquinone-type pigments, perylene and perynone-type pigments, thioindigo-type pigments, quinacridone-type pigments, dioxazine-type pigments, isoindolinone-type pigments, quinophthalone-type pigments, underglaze lake pigments, azine pigments, nitroso pigments, nitro pigments, natural pigments, fluorescent pigments, inorganic pigments, carbon black and so on.

Among these pigments, carbon black is particularly preferred, since it is a substance which well absorbs light in the near infrared to infrared range and being economically advantageous. As such carbon black, there have been marketed grafted carbon black products having various functional groups and being highly dispersible. Examples thereof include those described in Kabon Burakku Binran 3rd edition, edited by Carbon Black Kyokai, p. 167 (1995) and Kabon Burakku no Tokusei to Saiteki Haigo oyobi Riyo Gijutsu, Gijutsu Joho Kyokai, p. 111 (1997), etc. and any of these products can be appropriately employed herein.

Such a pigment may be used without any surface treatment. Alternatively, it may be subjected to a publicly known surface-treatment before using. Examples of publicly known surface-treatment methods include a method of coating the surface with a resin or a wax, a method of attaching a surfactant, a method of bonding a reactive substance (for example, a silane coupling agent, an epoxy compound, a polyisocyanate or the like) to the surface of the pigment, etc. These surface-treatment methods are reported in Kinzoku Sekken no Seishitu to Oyo (Saiwai Shobo), Saishin Ganryo Oyo Gijutsu (CMC Shuppan, 1986) and Insatsu Inki Gijutsu (CMC Shuppan, 1984).

The particle size of the pigment to be used in the invention preferably ranges from 0.01 to 15 μm, more preferably from 0.01 to 5 μm.

As the dye to be used in the invention, use can be made of publicly known ones commonly employed. Examples thereof include those described in, for example, Senryo Binran, edited by Yukigosei Kagaku Kyokai (1970), Shikizai-Kogaku Handbook, edited by Shikizai-kyokai, Asakura Shoten (1989), Kogyoyo Shikiso no Gijutsu to Ichiba, CMC (1983) and Kagaku Binran Oyo Kagaku-hen, edited by The Chemistry Society of Japan, Maruzen Shoten (1986 ). As specified examples thereof, there can be enumerated azo dyes, metal chain salt azo dyes, pyrazolone azo dyes, anthraquinone dyes, phthalocyanine dyes, carbonium dyes, quinone imine dyes, methine dyes, cyanine dyes, indigo dyes, quinoline dyes, nitro dyes, xanthene dyes, thiazine dyes, azine dyes, oxazine dyes, and so on.

As dyes absorbing light in the near infrared to infrared range, there can be enumerated, for example, cyanine dyes, methine dyes, naphthoquinone dyes, squaryliun pigments, aryl benzo(thio)pyridinium salts, trimethine thiapyrylium salts, pyrylium compounds, pentamethine thiopyrylium salt, IR-absorbing dyes, and so on.

Among these dyes, a near infrared absorbing cationic dye represented by the following formula is preferred, since it contributes to the efficient polymerization performance of a photopolymerization initiator as will be described hereinafter.

D⁺A⁻

In the above formula, D⁺ represents a cationic dyestuff having an absorption in a near infrared range, and A⁻ represents an anion.

Examples of the cationic dyestuff having an absorption in a near infrared range include cyanine-based dyestuffs, triarylmethane-based dyestuffs, aminium-based dyestuffs, diimmonium-based dyestuffs, and so on. As specific examples of the cationic dyestuff having an absorption in a near infrared range, the following ones can be enumerated.

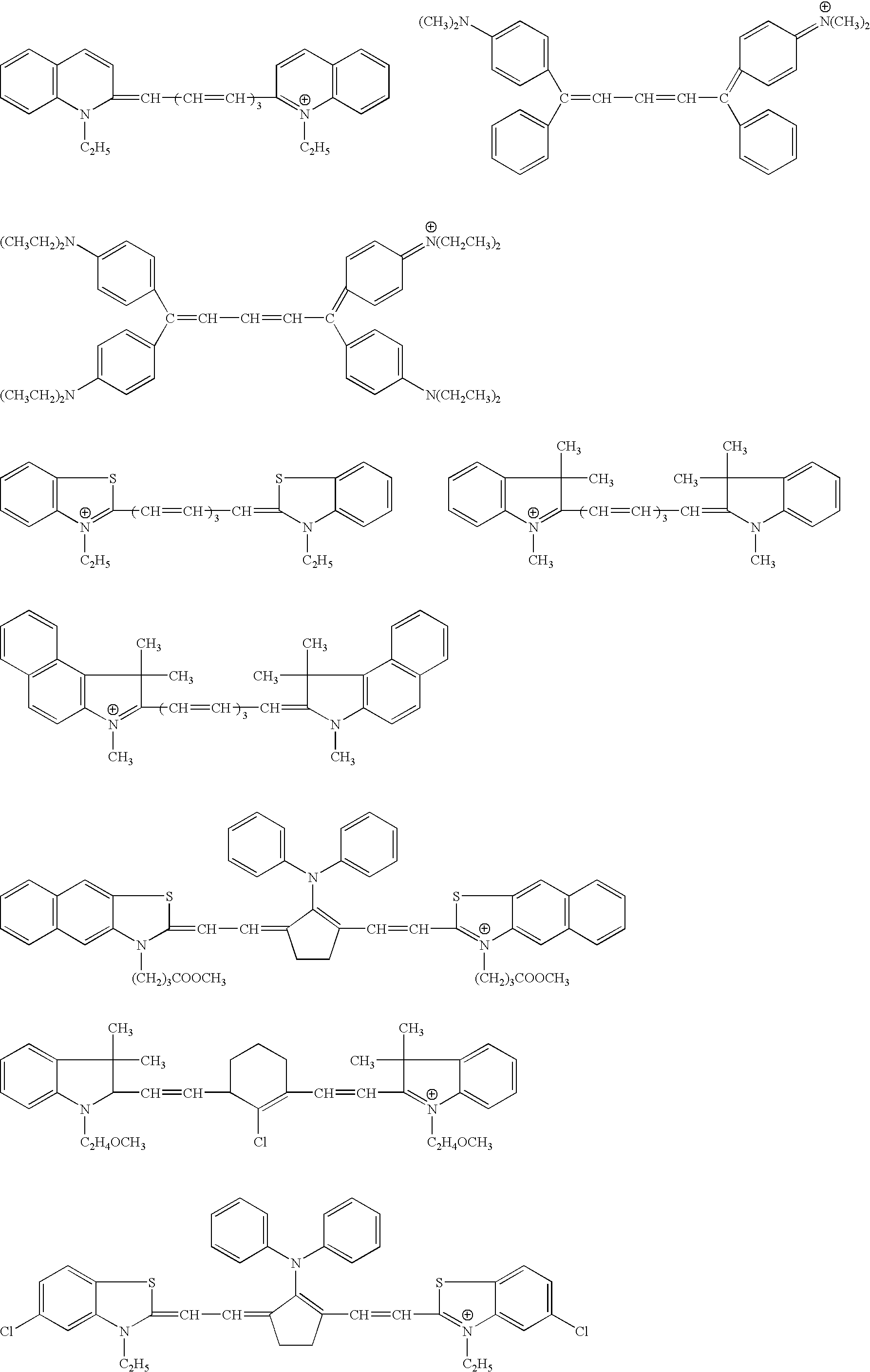

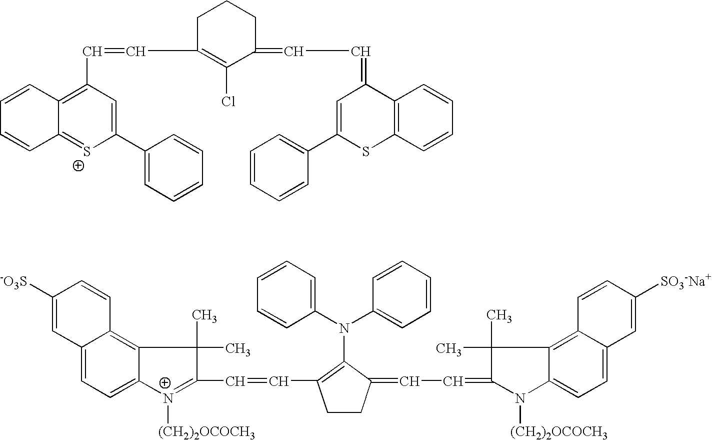

Examples of the anion include halogen anions, ClO₄⁻, PF₆⁻, BF₄⁻, SbF₆⁻, CH₃SO₃⁻, CF₃SO₃⁻, C₆H₅SO₃⁻, CH₃C₆H₄SO₃⁻, HOC₆H₄SO₃⁻, ClC₆H₄SO₃⁻, boron anions represented by the following formula (3), and so on. The boron anion is preferably a triphenyl n-butylboron anion or a trinaphthyl n-butylboron anion.

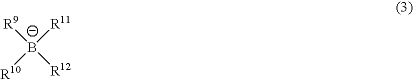

In the above formula, R⁹, R¹⁰, R¹¹ and R¹² each independently represents an alkyl group, an aryl group, an alkaryl group, an allyl group, an aralkyl group, an alkenyl group, an alkynyl group, an alicyclic group or a saturated or unsaturated heterocyclic group, provided that at least one of R⁹, R¹⁰, R¹¹ and R¹² is an alkyl group having 1 to 8 carbon atoms.

Among cationic dyestuffs having an absorption in a near infrared range, preferred is a dyestuff represented by the following formula (4). Since such a dyestuff has a maximum absorption wavelength within a range from 817 to 822 nm, the resulting lithographic printing plate precursor is suitable for an exposure apparatus equipped with an existing near infrared semiconductor laser. As the molar absorption coefficient thereof is 1×10⁵ or more, the resulting lithographic printing plate precursor has an excellent sensitivity.

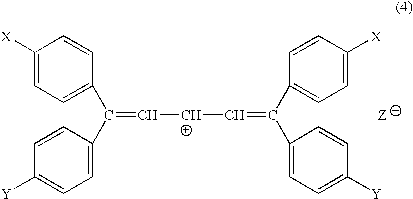

In the above formula X represents N(C₂H₅)₂ or N(CH₃)₂, Y represents N(C₂H₅)₂, H, or OCH₃, and Z⁻ is an anion represented by any one of the following formulae.

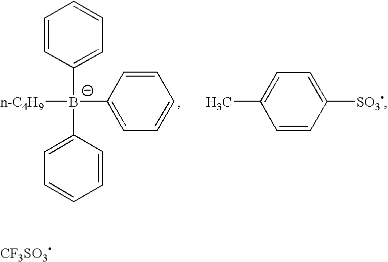

The infrared absorbing agent is used by selecting at least one proper pigment or dye capable of absorbing a specific wavelength of a light source as will be described hereinafter from the above-described pigments or dyes and then adding to the image forming layer.

In the case of using a pigment as the infrared absorbing agent, the content of the pigment is preferably within a range from 0.5 to 15 mass %, and particularly preferably from 1 to 10 mass %, based on the total solid content of the image forming layer. When the content of the pigment is less than 0.5 mass %, infrared light is not sufficiently absorbed. On the other hand, when the content of the pigment is more than 15 mass %, an excess quantity of heat tends to be generated, and therefore it is not preferred.

In the case of using a dye as the infrared absorbing agent, the content of the dye is preferably within a range from 0.5 to 15 mass %, and particularly preferably from 1 to 10 mass %, based on the total solid content of the image forming layer When the content of the dye is less than 0.5 mass %, infrared light is not sufficiently absorbed. On the other hand, when the content of the dye is more than 15 mass %, absorption of infrared lights is substantially saturated and the effect of the addition of the dye may not increase, and therefore it is not preferred.

### <Photopolymerization Initiator>

As a photopolymerization initiator, use can be made of an appropriate one selected from among various publicly known photopolymerization initiators reported in patent documents, non-patent documents and so on or a system comprising a combination of two or more photopolymerization initiators (a photopolymerization initiator system) depending on the wavelength of a light source to be employed. In the invention, both of a photopolymerization initiator employed alone and a system comprising a combination of two or more photopolymerization initiators are merely called “a photopolymerization initiator”.

As the photopolymerization initiator, it is appropriate to use an organoboron compound, an onium salt or a triazine compound. Either one of these photopolymerization initiators or a combination of two or more of the same may be used.

The organoboron compound exerts the function as a polymerization initiator when used together with the infrared absorbing agent as described above. The organoboron compound is preferably an ammonium salt of a quaternary boron anion represented by the following formula (5).

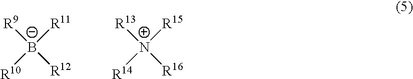

In the above formula, R⁹, R¹⁰, R¹¹ and R¹² independently represent each an alkyl group, an aryl group, an alkaryl group, an allyl group, an aralkyl group, an alkenyl group, an alkynyl group, an alicyclic group, or a saturated of unsaturated heterocyclic group, provided that at least one of R⁹, R¹⁰, R¹¹ and R¹²is an alkyl group having 1 to 8 carbon atoms. R¹³, R¹⁴, R¹⁵ and R¹⁶ independently represent each a hydrogen atom, an alkyl group, an aryl group, an allyl group, an alkaryl group, an aralkyl group, an alkenyl group, an alkynyl group, an alicyclic group, or a saturated or unsaturated heterocyclic group.

Among these organoboron compounds, use can be preferably made of tetra n-butylammonium triphenylboron, tetra n-butylammonium trinaphthylboron, tetra n-butylammonium tri(p-t-butylphenyl)boron, tetramethylammonium n-butyltriphenylboron, tetramethylammonium n-butyltrinaphthylboron, tetramethylammonium n-octyltriphenylboron, tetramethylammonium n-octyltrinaphthylboron, tetraethylammonium n-butyltriphenylboron, tetraethylammonium n-butyltrinaphthylboron, trimethylhydrogenammonium n-butyltriphenylboron, triethylhydrogenammonium n-butyltriphenylboron, tetrahydrogenammonium n-butyltriphenylboron, tetramethylammonium tetra n-butylboron, tetraethylammonium tetra n-butylboron, etc., because of capable of efficiently exerting the polymerization function.

When combined with the infrared absorbing agent as described above (for example, D⁺A⁻), the organoboron compound can function as a polymerization initiator by irradiation with infrared light to generate a radical (R.), as shown by the following formula (6) (wherein Ph represents a phenyl group, R. represents an alkyl group having 1 to 8 carbon atoms, and X⁺ represents an ammonium ion).

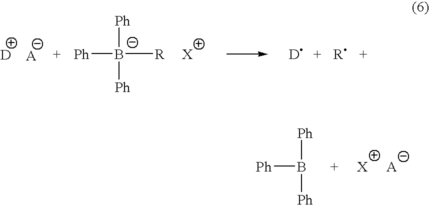

The content of the organoboron compound is preferably within a range from 0.1 to 15 mass %, and particularly preferably from 0.5 to 7 mass %, based on the solid content of the image forming layer. When the content of the organoboron compound is less than 0.1 mass %, insufficient polymerization reaction causes insufficient curing, resulting in weak image area of the negative-working photosensitive lithographic printing plate. On the other hand, when the content of the organoboron compound exceeds 15 mass %, the polymerization reaction does not proceed efficiently. If necessary, two or more organoboron compounds may be used.

The onium salt is a salt comprising a cation having at least one onium ion atom in the molecule and an anion. Examples of the onium ion atom in the onium salt include S⁺ in sulfonium, I⁺ in iodonium, N⁺ in ammonium, and P⁺ atom in phosphonium and so on. Among these onium ion atoms, S⁺ and I⁺ atoms are preferable. Examples of the structure of the onium salt include triphenyl phosphonium and its derivative having an alkyl group, an aryl group, etc. introduced into the benzene ring of the compound, and it derivatives having an alkyl group, an aryl group, etc. introduced into the benzene ring of the compound.

Examples of the anion of the onium salt include halogen anion, ClO₄⁻, PF₆⁻, BF₄⁻, SbF₆⁻, CH₃SO₃⁻, CF₃SO₃⁻, C₆H₅SO₃⁻, CH₃C₆H₄SO₃⁻, HOC₆H₄SO₃⁻, ClC₆H₄SO₃⁻, and boron anion represented by the above formula (3).

In view of sensitivity and storage stability, the onium salt is preferably obtained by combining an onium salt having S⁺ in the molecule with an onium salt having I⁺ in the molecule. In view of sensitivity and storage stability, the onium salt is also preferably a polyvalent onium salt having at least two onium ion atoms per molecule. At least two onium ion atoms in the cation are bonded through a covalent bond. Among polyvalent onium salts, those having at least two onium ion atoms per molecule are preferable and those having S⁺ and I⁺ per molecule are particularly preferable. Particularly preferable polyvalent onium salts are represented by the following formulae (7) and (8).

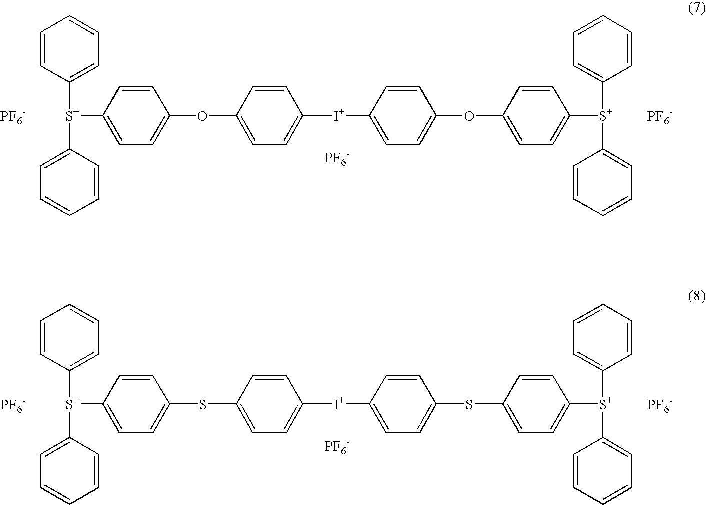

The content of the onium salt is preferably within a range from 0.1 to 15 mass %, and particularly preferably from 0.5 to 7 mass %, based on the solid content of the image forming layer. When the content of the onium salt is less than 0.1 mass %, the resulting negative-working photosensitive lithographic printing plate may be insufficient in sensitivity and printing durability because of insufficient polymerization reaction. On the other hand, when the content of the onium salt exceeds 15 mass %, the resulting negative-working photosensitive lithographic printing plate is inferior in developing properties.

If necessary, two or more onium salts may be used in combination. Also the polyhydric onium salt may be used in combination with the onium salt.

As the triazine compound which is a publicly known polymerization initiator having been employed radical polymerization, use can be appropriately made of, for example, a bis(trihalomethyl)-s-triazine, etc. as a photopolymerization initiator. The triazine compound is usually employed only in a small amount. In the case of using the triazine compound in an inappropriately large amount, it causes some undesirable results such as blocking effective rays or crystallization in the image-forming layer which results in re-deposition after coating. The content of the triazine compound is preferably within a range from 0.1 to 15 mass % based on the solid content of the image forming layer. Favorable results can be obtained by using it, in particular, in an amount of from 0.5 to 7 mass %.

It is also possible to add an arbitrary promoter, for example, a mercapto compound such as 3-mercaptotriazole, an amine compound, etc. to the photopolymerization initiator.

### <Binder Resin Having Functional Group Becoming Hydrophobic Upon Exposure>

The binder resin having a functional group which becomes hydrophobic upon exposure to be used in the invention (hereinafter also called the polymer having a polarity-changing group) “(preferably irreversibly) switches” the nature an exposed area into a less hydrophilic (i.e., more hydrophobic) one. Thus, the hydrophilicity of the image forming layer is changed imagewise and the fountain water-permeability of the image area is further lowered. This can be established by using a hydrophilic heat-sensitive polymer in which ionic groups repeatedly occur in the main polymer chain or are chemically bonded to the main polymer chain.

Although such a material has been used as a material in which an unexposed area serves as a water-receiving non-image area while an exposed area serves as an ink-receiving image area, it cannot achieve any sufficient printing performance when employed alone because of the poor discrimination between the image area and the non-image area. In the embodiment of the present invention, it is clarified that a new function of on-press developability can be established by imparting fountain solution-permeability to the image forming layer in the non-image area. Moreover, the polarity change makes it possible to further regulate the fountain solution-permeability of the image area and improve printing durability.

Now, the above-described polymer and group will be described in greater detail.

The polymer having a polarity-changing group comprises repeating units at least 20% of which contain an ionic group. It is preferable that at least 30% by mol of the repeatedly occurring groups contain an ionic group. Therefore, each polymer has the total charge imparted by these ionic groups. As the ionic groups, cationic groups are preferred.

A charged polymer that is useful in carrying out the invention falls within either of the following two broad-ranged material classes.

(Class I): Crosslinked or uncrosslinked vinyl polymers comprising repeating units containing positively-charged, pendant N-alkylated aromatic heterocyclic groups.

(Class II): Crosslinked or uncrosslinked polymers comprising repeating organoonium groups.

Next, each class of polymers will be described in turn. The image forming layer can contain mixtures of polymers from each class, or a mixture of one or more polymers from both classes. The Class II polymers are preferred.

Class I Polymers: The Class I polymers generally have a molecular weight of at least 1000 and can be any of a wide variety of hydrophilic vinyl homopolymers and copolymers having the required positively-charged groups. They are prepared from ethylenically unsaturated polymerizable monomers using any conventional polymerization technique. Preferably, the polymers are copolymers prepared from two or more ethylenically unsaturated polymerizable monomers, at least one of which contains the desired pendant positively-charged group, and another monomer that is capable of providing other properties, such as on-press developability and adhesion to the support. Procedures and reactants needed to prepare these polymers are well known.

When a cationic group reacts with its counter ion, the cationic group apparently provides or promotes the switching of the image forming layer from hydrophilic to hydrophobic in the area that has been exposed to light in some manner. As a result, the net charge is decreased. Such a reaction can be more easily accomplished when the anion is more nucleophilic and/or more basic. For example, an acetate anion is usually more reactive than a chloride anion. By changing the chemical nature of the anion, it becomes possible to control the reactivity of the heat-sensitive polymer so as to provide optimal image resolution for a given set of conditions (for example, laser hardware and power, and printing press needs) matching for sufficient ambient shelf life. Examples of useful anions include halide ions, carboxylates, sulfates, borates and sulfonates. Typical examples of the anions include, but are not limited to, chloride ion, bromide ion, fluoride ion, acetate, tetrafluoroborate, formate, sulfate, p-toluenesulfonate and so on which are readily apparent to a person skilled in the art. The halides and carboxylates are preferred.

To impart desired hydrophobicity to the printing layer having an image formed by the heat activation reaction as described above, the aromatic cationic group is present in a sufficient number of repeating units of the polymer. The groups may be attached either along the main chain of the polymer or to one or more branches of the polymer network. The aromatic groups generally comprise 5 to 10 carbon, nitrogen, sulfur or oxygen atoms in the ring (at least one being a positively-charged nitrogen atom)and a branched or unbranched, substituted or unsubstituted alkyl group is attached thereto. Thus, the repeating units containing the aromatic heterocyclic group can be represented by the following structural formula I.

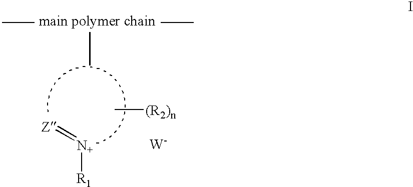

In this structure, R₁ represents a branched or unbranched, substituted or unsubstituted alkyl group having from 1 to 12 carbon atoms (for example, methyl, ethyl, n-propyl, isopropyl, t-butyl, hexyl, methoxymethyl, benzyl, neopentyl or dodecyl). Preferably, R₁ is a substituted or unsubstituted, branched or unbranched alkyl group having from 1 to 6 carbon atoms, and most preferably, R₁ is substituted or unsubstituted methyl group.

R₂ can be a substituted or unsubstituted alkyl group (those as described above, and additionally a cyanoalkyl group, a hydroxyalkyl group or alkoxyalkyl group), a substituted or unsubstituted alkoxy group having 1 to 6 carbon atoms (for example, methoxy, ethoxy, isopropoxy, oxymethylmethoxy, n-propoxy or butoxy), a substituted or unsubstituted aryl group having 6 to 14 carbon atoms in the ring (for example, phenyl, naphthyl, anthryl, p-methoxyphenyl, xylyl, or alkoxycarbonylphenyl), a halo (for example, chloro or bromo), a substituted or unsubstituted cycloalkyl group having 5 to 8 carbon atoms in the ring (for example, cyclopentyl, cyclohexyl or 4-methylcyclohexyl), or a substituted or unsubstituted heterocyclic group having 5 to 8 atoms in the ring including at least one nitrogen, sulfur or oxygen atom in the ring (for example, pyridyl, pyridinyl, tetrahydrofuranyl or tetrahydropyranyl). Preferably, R₂ is substituted or unsubstituted methyl or ethyl group.

Z″ represents carbon or any additional nitrogen, oxygen, or sulfur atoms necessary to complete the 5- to 10-membered aromatic N-heterocyclic ring attached to the main polymer chain. Namely, the ring can contain two or more nitrogen atoms therein (for example, an N-alkylated diazinium or imidazolium group). As an N-alkylated nitrogen-containing fused ring system, there can be enumerated pyridinium, quinolinium, isoquinolinium acridinium, phenanthradinium and others readily apparent to a person skilled in the art.

W⁻ is an appropriate anion as described above. Most preferably W⁻ is an acetate or chloride ion. In Structure I, n is defined as 0 to 6, and is preferably 0 or 1 and most preferably 0.

The aromatic heterocyclic ring may be attached to the main polymer chain at an arbitrary position on the ring. It is preferable that there are 5 or 6 atoms in the ring, one or two of which are nitrogen. Thus, the N-alkylated nitrogen-containing aromatic group is preferably imidazolium or pyridinium and more preferably it is imidazolium.

The repeating units containing the cationic aromatic heterocycle can be provided by reacting a precursor polymer containing unalkylated nitrogen-containing heterocyclic units with an appropriate alkylating agent (for example, an alkyl sulfonate ester, an alkyl halide or other materials readily apparent to a person skilled in the art) with the use of widely known procedures and conditions.

Preferred Class I polymers can be represented by the following Structure II.

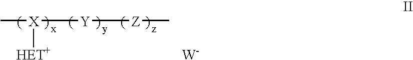

In the above formula, X represents repeating units to which the N-alkylated nitrogen-containing aromatic heterocyclic groups (represented by HET⁺) are attached; Y represents repeating units derived from ethylenically unsaturated polymerizable monomers that may provide active sites for crosslinking using any of various crosslinking mechanisms (as will be described below); and Z represents repeating units derived from any additional ethylenically unsaturated polymerizable monomers.

These repeating units are present in suitable amounts, that is, x ranges from 20 to 100% by mol, y ranges from 0 to 20% by mol, and z ranges from 0 to 80% by mol. It is preferable that x is from 30 to 98% by mol, y is from 2 to 10% by mol and z is from 0 to 68% by mol.

The crosslinking of the polymers can be performed by various methods. There are numerous monomers and methods for crosslinking that are well known by a person skilled in the art. Monomers having crosslinkable groups or active crosslinkable sites (or groups that can serve as attachment points for crosslinking additives, such as epoxides) can be copolymerized with the other monomers as described above. Examples of such monomers include, but are not limited to, 3-(trimethoxysilyl)propyl acrylate or methacrylate, cinnamyl acrylate or methacrylate, N-methoxymethyl methacrylamide, N-aminopropylacrylamide hydrochloride, acrylic or methacrylic acid and hydroxyethyl methacrylate.

Additional monomers that provide the repeating units represented by “Z” in the above structural formula II include any useful hydrophilic or lipophilic ethylenically unsaturated polymerizable monomers capable of imparting desired physical or printing properties to the hydrophilic image forming layer. Examples of such monomers include, but are not limited to, acrylates, methacrylates, isoprene, acrylonitrile, styrene and styrene derivatives, acrylamides, methacrylamides, acrylic or methacrylic acid and vinyl halides.

The Class II polymers also generally have a molecular weight of at least 1000. They can be any of a wide variety of vinyl or non-vinyl homopolymers and copolymers. Examples of the non-vinyl polymers belonging to Class II include, but are not limited to, polyesters, polyamides, polyamide-esters, polyarylene oxides and derivatives thereof, polyurethanes, polyxylylenes and derivatives thereof, polyamidoamines, polyimides, polysulfones, polysiloxanes, polyethers, poly(ether ketones), poly(phenylene sulfide) ionomers, polysulfides and polybenzimidazoles. It is preferable that the non-vinyl polymers are polyarylene oxides, poly(phenylene sulfide) ionomers or polyxylylenes, most preferably poly(phenylene sulfide) ionomers. Procedures and reactants needed to prepare all of these types of polymers are well known. In accordance with the additional teaching provided herein, a person skilled in the art can modify the known polymer reactants and conditions to incorporate or attach a suitable cationic organoonium moiety.

When the cationic moiety reacts with its counterion, the organoonium moiety having been chemically incorporated into the polymer apparently provides or facilitates the switching of the image forming layer from hydrophilic to lipophilic in the exposed area that is exposed to energy providing or generating heat. As a result, the net charge is decreased. Such a reaction can be more easily accomplished when the anion is more nucleophilic and/or more basic, as discussed above with respect to Class I polymers.

The organoonium moiety within the polymer can be chosen from a trisubstituted sulfur moiety (organosulfonium), a tetrasubstituted nitrogen moiety (organoammonium), or a tetrasubstituted phosphorous moiety (organophosphonium). The tetrasubstituted nitrogen (organoammonium) moiety is preferred. This moiety can be either chemically attached to the main polymer chain or incorporated into the main chain in some mode. In either embodiment, the organoonium moiety is present in sufficient number of repeating units of the polymer (at least 20% by mol) so that the heat-activated reaction as described above can occur to thereby impart the desired hydrophobicity to the image forming layer. In the case where the organoonium moiety is chemically attached as a pendant group, it can be attached along the principal main polymer chain, or to one or more branches of a polymeric network, or both. In the case where the the organoonium moiety is chemically incorporated within the main polymer chain, the moiety can be present in either cyclic or acyclic form, and can also form a branching point in a polymer network. It is preferable that the organoonium moiety is provided as a pendant group along the polymeric backbone. After the formation of the pendant, the pendant organoonium moieties can be chemically attached to the the main polymer chain. It is also possible to convert a functional group on the polymer into an organoonium moiety by using a known chemical reaction. For example, pendant quaternary ammonium groups can be provided on the main polymer chain by substituting a “leaving functional group” (for example, a halogen) by a tertiary amine nucleophile. Alternatively, the organoonium group can be present on a monomer followed by the polymerization of the monomer or the organoonium group can be derived by the alkylation of a neutral heteroatom unit (a trivalent nitrogen or phosphorous group or divalent sulfur group) that has been already incorporated within the polymer.

The organoonium moiety is substituted to provide a positive charge. Each substituent must have at least one carbon atom that is directly attached to the sulfur, nitrogen or phosphorus atom of the organoonium moiety. Examples of useful substituents include, but are not limited to, substituted or unsubstituted alkyl groups having 1 to 12 carbon atoms and preferably from 1 to 7 carbon atoms (for example, methyl, ethyl, n-propyl, isopropyl, t-butyl, hexyl, methoxyethyl and isopropoxymethyl), substituted or unsubstituted aryl groups (for example, phenyl, naphthyl, p-methylphenyl, m-methoxyphenyl, p-chlorophenyl, p-methylthiophenyl, p-N,N-dimethylaminophenyl, xylyl, methoxycarbonylphenyl and cyanophenyl), and substituted or unsubstituted cycloalkyl groups having 5 to 8 carbon atoms in the carbocyclic ring (for example, cyclopentyl, cyclohexyl, 4-methylcyclohexyl and 3-methylcyclohexyl). Other useful substituents would be readily apparent to a person skilled in the art. Also, any combination of the substituents described herein is to be taken into consideration.

To carry out the invention, use can be also made of vinyl Class II polymers. Similar to the non-vinyl polymers, such heat-sensitive polymers are composed of repeating units having one or more types of organoonium group. For example, such a polymer can have repeating units having both organoammonium groups and organosulfonium groups. It is not necessary that all of the organoonium groups have the same alkyl substituents. For example, a polymer can have repeating units having two or more types of organoammonium groups. Examples of anions useful in these polymers are the same as those described above for the non-vinyl polymers. In addition, the halides and carboxylates are preferred.

The organoonium moiety is present in sufficient number of repeating units of the polymer so that the heat-activated reaction as described above can occur to thereby impart the desired hydrophobicity to the printing layer having an image formed thereon. This group can be attached along the principal main polymer chain, or to one or more branches of a polymeric network, or both. After the formation of the pendant, the pendant organoonium moieties can be chemically attached to the the main polymer chain by using a well known chemical reaction. For example, pendant organoammonium, organophosphonium or organosulfonium groups can be provided on the main polymer chain by substituting a “leaving functional group” (for example, a halide or a sulfonate ester) by a tetra-valent amine or trivalent phosphorus nucleophile. Also, the a pendant onium group can be provided by the alkylation of the corresponding pendant neutral heteroatom unit (a nitrogen, sulfur or phosphorous group) by using an arbitrary alkylating agent commonly employed such as an alkyl sulonate ester or an alkyl halide. Alternatively, a desired polymer can be obtained by polymerizing a monomer precursor having a desirable organoammonium, organophosphonium or organosulfonium group.

The organoammonium, organophosphonium or organosulfonium group in the vinyl polymer provides a desired positive charge. Generally preferable examples of the pendant organoonium group can be represented by the following structural formulae III, IV and V.

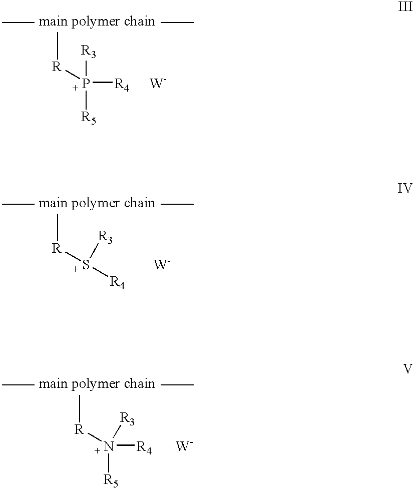

In the above formulae, R represents a substituted or unsubstituted alkylene group having 1 to 12 carbon atoms that can also include one or more oxy, thio, carbonyl, amido or alkoxycarbonyl groups within the chain (for example, methylene, ethylene, isopropylene, methylenephenylene, methyleneoxymethylene, n-butylene or hexylene), a substituted or unsubstituted arylene group having 6 to 10 carbon atoms in the ring (for example, phenylene, naphthylene, xylylene or 3-methoxyphenylene), or a substituted or unsubstituted cycloalkylene group having 5 to 10 carbon atoms in the ring (for example, 1,4-cyclohexylene or 3-methyl-1,4-cyclohexylene). In addition, R can be a combination of two or more of the above-described substituted or unsubstituted alkylene, arylene and cycloalkylene groups. It is preferable that R is a substituted or unsubstituted ethyleneoxycarbonyl or phenylenemethylene group. Other useful substituents not listed herein could include combinations of any of those groups listed above are readily apparent to a person skilled in the art.

R₃, R₄ and R₅ independently represent each substituted or unsubstituted alkyl group having 1 to 12 carbon atoms (for example, methyl, ethyl, n-propyl, isopropyl, t-butyl, hexyl, hydroxymethyl, methoxymethyl, benzyl, methylenecarboalkoxy or cyanoalkyl), a substituted or unsubstituted aryl group having 6 to 10 carbon atoms in the carbocyclic ring (for example, phenyl, naphthyl, xylyl, p-methoxyphenyl, p-methylphenyl, m-methoxyphenyl, p-chlorophenyl, p-methylthiophenyl, p-N,N-dimethylaminophenyl, methoxycarbonylphenyl or cyanophenyl), or a substituted or unsubstituted cycloalkyl group having 5 to 10 carbon atoms in the carbocyclic ring (for example, 1,3- or 1,4-cyclohexyl). Alternatively, any two of R₃, R₄ and R₅ may be combined to form a substituted or unsubstituted heterocyclic ring together with the charged phosphorus, sulfur or nitrogen atom and the ring has 4 to 8 carbon, nitrogen, phosphorus, sulfur or oxygen atoms in the ring. Examples of the heterocyclic ring include, but are not limited to, substituted or unsubstituted morpholinium, piperidinium and pyrrolidinium groups for Structure V. Other examples of useful substituents for these various groups would be readily apparent to a person skilled in the art, and any combinations of the substituents described herein is to be taken into consideration.

It is preferable that R₃, R₄ and R₅ independently represent each a substituted or unsubstituted methyl or ethyl group. W⁻ is an arbitrary appropriate anion as described above with respect to Class I polymers. Acetate and chloride are preferred anions. Polymers containing quaternary ammonium groups as described herein are most preferred vinyl Class II polymers.

In preferred embodiments, vinyl Class II polymers useful in carrying out the invention are represented by the following structural formula VI.

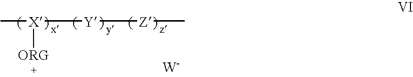

In the above formula, X′ represents repeating units to which the organoonium groups (“ORG”) are attached. Y′ represents repeating units derived from ethylenically unsaturated polymerizable monomers that may provide active sites for crosslinking with the use of any of various crosslinking mechanisms (as will be described below). Z′ represents repeating units derived from arbitrary additional ethylenically unsaturated polymerizable monomers. The various repeating units are present in suitable amounts, that is, x′ ranges from 20 to 99% by mol, y′ ranges from 1 to 20% by mol, and z′ ranges from 0 to 79% by mol. It is preferable that x′ is from 30 to 98% by mol, y′ is from 2 to 10% by mol and z′ is from 0 to 68% by mol. The crosslinking of the vinyl polymer can be achieved in the same way as described above with respect to Class I polymers.

Additional monomers that provide the additional repeating units represented by Z′ in Structure VI include any useful hydrophilic or lipophilic ethylenically unsaturated polymerizable monomer that may provide desired physical or printing properties to the image forming layer. Examples of the monomers include, but are not limited to, acrylates, methacrylates, acrylonitrile, isoprene, styrene and styrene derivatives, acrylamides, methacrylamides, acrylic or methacrylic acid and vinyl halides.

Typical examples of Class II vinyl polymers include: poly[methyl methacrylate-co-2-trimethylammoniumethyl methacrylic chloride-co-N-(3-aminopropyl)methacrylamide hydrochloride] (molar ratio 7:2:1); poly[methyl methacrylate-co-2-trimethylammoniumethyl methacrylic acetate-co-N-(3-aminopropyl)methacrylamide] (molar ratio 7:2:1); poly[methyl methacrylate-co-2-trimethylammoniumethyl methacrylic fluoride-co-N-(3-aminopropyl)methacrylamide hydrochloride] (molar ratio 7:2:1); poly[vinylbenzyl trimethylammonium chloride-co-N-(3-aminopropyl)methacrylamide hydrochloride] (molar ratio 19:1); poly([vinylbenzyltrimethyl-phosphonium acetate-co-N-(3-aminopropyl)methacrylamide hydrochloride] (molar ratio 19:1), vinylbenzyl bromide (60:40 mixture of p- and m-isomers); poly[dimethyl-2-(methacryloyloxy)ethylsulfonium chloride-co-N-(3-aminopropyl)methacreylamide hydrochloride] (molar ratio 19:1); poly[vinylbenzyldimethylsulfonium methylsulfate]; poly(vinylbenzyldimethylsulfonium chloride]; poly(N,N,N,N-p-vinylbenzyl(2-trimethylammoniumethyl)dimethylammonium dichloride-co-aminopropylmethacrylamide hydrochloride) (molar ratio 9:1); and poly(vinylbenzyl trimethylammonium chloride-co-methacrylic acid) (molar ratio 94:6). Among all, poly[vinylbenzyl trimethylammonium chloride-co-N-(3-aminopropyl)methacrylamide hydrochloride) (molar ratio 19:1) is most preferable from the viewpoint of changing polarity. Use can be also made of a mixture of two or more of these polymers.

The image forming layer of the invention contains one or more Class I or II polymers optionally together with minor amounts (less than 20 mass %, based on the total solid content of the image forming layer) of additional binder or polymeric materials that will not adversely affect the image formation properties.

The content of the polymer having a polarity-changing group is from 1 to 90 mass %, preferably from 1 to 50 mass % and more preferably from 5 to 30 mass %, based on the total solid content of the image forming layer.

### <Other Binder Resins>

In addition to the above-described polymer having a polarity-changing group, the image forming layer of the invention may contain, if needed, other binder resins within a range (less than 20 mass %, based on the total solid content of the image forming layer) not adversely affecting the image forming properties such as film properties of the image forming layer and improvement in developability.

Examples of the binder resins capable of improving the film properties of the image forming layer include acrylic resins, polyvinylacetal resins, polyurethane resins, polyurea resins, polyimide resins, polyamide resins, epoxy resins, methacrylic resins, polystyrene-based resins, novolac phenol-based resins, polyester resins, synthetic rubbers and natural rubbers.

Among them, it is preferable to use an acrylic resin such as polymethyl methacrylate or polyethyl methacrylate, or a polyurethane resin such as a polycondensation product of hexamethylene diisocyanate, xylylene diisocyanate and propylene glycol.

By introducing a radical reactive group into a side chain of such a polymer, the strength of a film made of the resultant the binder resin can be improved. Examples of an addition-polymerizable functional group include ethylenically unsaturated bond groups, an amino group, an epoxy group and so on. Examples of a group capable of serving as a radical upon light irradiation include a mercapto group, a thiol group, halogen atoms, triazine structures, onium salt structures and so on. Examples of a polar group include a carboxyl group, an imide group and so on. Although ethylenically unsaturated bond groups such as an acryl group, a methacryl group, an allyl group and a styryl group are preferable as the addition-polymerizable functional group as described above, use can be also made of a functional group selected from among an amino group, a hydroxy group, a phosphonate group, a phosphate group, a carbamoyl group, an isocyanate group, a ureido group, a ureylene group, a sulfonate group and an ammonio group.

It is also possible to use a hydrophilic binder resin so as to improve the on-press developability (i.e., the printing plate precursor is mounted on a printing press as such without developing after the image formation and a fountain solution and an ink are supplied thereto while rotating the cylinder to thereby remove an non-required image forming layer) and developability in the case of using a neutral developing solution after the image formation.

Preferable examples of the hydrophilic binder resin include those having a hydrophilic group such as a hydroxyl group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amide group, a carboxymethyl group, a sulfonate group and a phosphate group.

Specific examples of the hydrophilic resins include gum arabic, casein, gelatin, starch derivatives, carboxymethylcellulose and sodium salt thereof, cellulose acetate, sodium alginate, vinyl acetate-maleic acid copolymers, styrene-maleic acid copolymers, polyacrylic acids and salts thereof, polymethacrylic acids and salts thereof, homopolymers and copolymers of hydroxyethyl methacrylate, homopolymers and copolymers of hydroxyethyl acrylate, homopolymers and copolymers of hydroxypropyl methacrylate, homopolymers and copolymers of hydroxypropyl acrylate, homopolymers and copolymers of hydroxybutyl methacrylate, homopolymers and copolymers of hydroxybutyl acrylate, polyethylene glycol, hydroxypropylene polymers, polyvinyl alcohol, hydrolyzed polyvinyl acetate having a hydrolysis degree of at least 60% by mol, preferably at least 80% by mol, polyvinyl formal, polyvinyl butyral, polyvinyl pyrrolidone, homopolymers and copolymers of acrylamides, homopolymers and copolymers of methacrylamides, homopolymers and copolymers of N-methylolacrylamide, polyvinylpyrrolidone, alcohol-soluble nylon, polyether of 2,2-bis-(4-hydroxyphenyl)-propane and epichlorohydrin, and so on.

Among them, it is preferable to use a copolymer of polyethylene glycol monomethacrylate with another unsaturated group-containing compound.

Next, examples of the binder resin preferably usable in the invention will be presented in terms of monomer components constituting the same, though the invention is not restricted thereto.

Polyethylene glycol monomethacrylate/styrene/acrylonitrile=10/20/70 (mass-average molecular weight 80,000); polyethylene glycol monomethacrylate/methyl methacrylate/acrylonitrile=10/20/70 (mass-average molecular weight 80,000); polyethylene glycol monomethacrylate/methyl methacrylate=60/40 (mass-average molecular weight 60,000); polyethylene glycol monomethacrylate/acrylonitrile=30/70 (mass-average molecular weight 60,000); and so on.

From the viewpoint of improving on-press developability, it is preferable that the binder resin is in the form of particles which are dispersible in a polar solvent. In this state, polar groups such as ethylene glycol are oriented on the particle surface and thus the resin becomes hydrophilic, which contributes to the improvement in on-press developability.

In an exposed area, the particles are softened and molten due to the heat generated by the exposure. As a result, the surface hydrophilicity is blocked and thus a sufficient lipo-sensitivity can be obtained.

To obtain such a solvent-dispersible binder resin, use can be made of publicly known methods, but are not limited thereto, e.g., the method of forming particles in the course of polymerization such as dispersion polymerization, emulsion polymerization or interfacial polymerization, the method comprising dispersing a binder resin solution in a desired dispersion medium with the use of a dispersion device such as a homogenizer and then dissolving the binder resin.

Although the dispersion medium to be used is not particularly restricted, it is preferable from the viewpoint of on-press developability to use a polar solvent and a solvent and it is more preferable to use a solvent being the same as the coating solvent. More specifically speaking, use is appropriately made of the solvents to be used in dissolving a photosensitive composition in the step of forming the image forming layer as will be discussed hereinafter.

To sustain the developability of a lithographic printing plate precursor, it is particularly preferable that the binder resin employed is a high-molecule polymer which has a mass-average molecular weight of 5000 to 300,000 and 2 to 120 repeating alkylene oxide units.

The binder resin may be contained in an arbitrary amount in the image forming layer. When the content thereof exceeds 90 mass %, however, it is sometimes impossible to achieve favorable results in strength, etc. of an image formed by using the layer. Thus, the binder resin content preferably ranges from 1 to 50 mass %, more preferably 5 to 30 mass %.

The polymerizable compound as described above and the binder resin are employed preferably at a ratio by mass of 1/9 to 9/1, more preferably 2/8 to 8/2 and most preferably 3/7 to 7/3.

### <Other Additives>

To lower the concentration of oxygen, which inhibits the polymerization of the polymerizable compound upon exposure, in the image forming layer, an oxygen-blocking protective layer is formed on the image forming layer or a less oxygen-permeable compound is added to the image forming layer to thereby achieve the advantage of the invention. By promoting polymerization, an exposed area becomes more hydrophobic and thus the tolerance to fountain solution is improved.

Examples of the substance to be added to the image forming layer for preventing polymerization inhibition by oxygen include higher fatty acid derivatives such as behenic acid and behenic acid amide. The higher fatty acid derivative is localized on the surface of the image forming layer in the course of drying following coating, thereby exerting an effect of regulating the permeation of environmental (atmospheric) oxygen into the image forming layer. The content of the higher fatty acid derivative preferably ranges from about 0.1 mass % to about 10 mass % based on the total composition.

Further, it is also possible to employ a method of adding a polymer having a polar group or a high crystallinity. For this purpose, use can be appropriately made of polyvinyl alcohol which is well known as a material having good oxygen-blocking properties, polyacrylonitrile which is known as having comparable oxygen-blocking properties, polyvinyl chloride or its copolymer, or cellulose or its derivative. From the viewpoint of improving the on-press developability, it is preferable that such an oxygen-blocking polymer is in the form of particles dispersible in a polar solvent. Since the particle surface becomes hydrophilic, the on-press developability can be improved and, at the same time, the oxygen-blocking effect can be maintained. From the viewpoint of easiness in forming dispersible particles, it is most desirable to use solvent-dispersible particles of polyacrylonitrile or its copolymer. As the copolymerization component, a commonly employed material having an ethylenically unsaturated group can be used. Considering the copolymerizability with acrylonitrile, styrene, (meth)acrylic acid or methyl(meth)acrylate is preferably used. To the image forming layer, this oxygen-blocking polymer dispersion is added in an amount of 5 to 95 mass %, preferably 10 to 90 mass % and more preferably 20 to 90 mass %, based on the total solid content of the image forming layer.

It is preferable to add a small amount of a heat polymerization inhibitor to the image forming layer according to the invention in order to prevent the polymerizable compound from unnecessary heat polymerization during the production or storage of the image forming layer. Preferable examples of the heat polymerization inhibitor include hydroquinone, p-methoxyphenol, di-t-butyl-p-cresol, pyrogallol, t-butyl catechol, benzoquinone, 4,4′-thiobis(3-methyl-6-t-butylphenol), 2,2′-methylenebis(4-methyl-6-t-butylphenol), primary cerium salt of N-nitrosophenylhydroxylamine and aluminum salt of N-nitrosophenylhydroxylamine. It is preferable that the image forming layer contains the heat polymerization initiator in an amount of from about 0.01 to about 5 mass % based on the total components of the image forming layer. If necessary, a higher fatty acid derivative such as behenic acid or behenic acid amide may be added for preventing polymerization inhibition by oxygen. The higher fatty acid derivative may be localized on the surface of the image forming layer in the course of drying following coating. It is preferable to add the higher fatty acid derivative in an amount of 0.5 to 10 mass % based on the total components of the image forming layer.

To color the image forming layer, a coloring agent may be added thereto. Examples of the coloring agent include pigments such as phthalocyanine pigments (C.I. Pigment Blue 15:3, 15:4, 15:6, etc.), azo pigments, carbon black and titanium oxide, and dyes such as ethyl violet, crystal violet, azo dyes, anthraquinone dyes and cyanine dyes. The content of the dye and pigment is preferably about 0.5 mass % to about 5 mass % based on the total components of the image forming layer.

To improve the properties of a hardened film obtained from the image forming layer, it is also possible to add an inorganic filler or a plasticizer such as dioctyl phthalate, dimethyl phthalate or tricresyl phthalate. To improve the film properties of the coated surface, it is also possible to add a publicly known surfactant. Examples of the publicly known surfactant include fluorine-based surfactants, polyoxyalkylene-based nonionic surfactants and silicone-based surfactants such as dialkylsiloxane.

As the above-described inorganic filler, silica particles are preferable and denatured silica particles having modified surface properties are still preferable. Silica particles, which have been commonly used in the art comprise silicon dioxide (SiO₂) as the main component. The particle diameter of silica particles usually ranges from 1 nm to 1000 nm, preferably from 1 nm to 500 nm and more preferably from 1 nm to 100 nm. Silica particles are commercially available and examples thereof include Snowtex OL (particle diameter: 45 nm, an aqueous colloidal solution containing 20 mass % of silica) manufactured by Nissan Kagaku Co., Ltd., MKE-ST (particle diameter: 10 to 20 nm, a methyl ethyl ketone colloidal solution containing 30 mass % of silica), AEROSIL 130 (silica with particle diameter of 16 nm) manufactured by Nippon Aerosil Cl., Ltd., Mizukasil P-527U (silica with particle diameter of 60 nm) manufactured by Mizusawa Industrial Chemicals, Ltd., etc.

Silica particles occur as fumed silica, precipitated silica, colloidal silica and so on. Among them, it is preferable to use colloidal silica.

It is preferable to use the above-described silica particles as a denatured silica particles which have been surface-modified with an organic compound having at least one ethylenically unsaturated group, at least one hydrophilic site and at least one silyloxy group. The ethylenically unsaturated group imparts reactivity with the polymerizable compound, while the silyloxy group imparts bindability to the silica particles. The ethylenically unsaturated group and the silyloxy group are preferably located at the both ends of the molecular chain of the organic compounds. In this case, the lipophilic site is located between the ethylenically unsaturated group and the silyloxy group. It is preferable, but not limited thereto, that the hydrophilic site include is a polyoxyalkylene chain which may be either a polyethylene chain, a polypropylene chain or a polyethylene-polyoxypropylene chain. Among all, a polyethylene chain is preferred. More specifically speaking, it is preferable that the organic compound as described above is one having the following formula.

CH₂═CH—COO—(CH₂CH₂O)ₘ—(CH₂CH(CH₃)O)ₙ—CO—X

—(CH₂)ₒ—(CHY)ₚ—(CH₂)_{q}—Si(OR)₃

In the above formula, R represents an alkyl group having 1 to 6 carbon atoms, preferably a methyl group or en ethyl group; X represents a divalent organic group selected from among —CH₂—, —O—, —S— and —NZ- (wherein Z represents H or an alkyl group having 1 to 6 carbon atoms), preferably H; and Y represents an alkyl group having 1 to 6 carbon atoms or a halogen atom, preferably a methyl group or a fluorine atom. m is an integer of from 0 to 100, preferably from 1 to 50, and n is an integer of from 0 to 100, preferably from 0 to 20, provided that m+n is 1 or more. o is an integer of from 0 to 10, preferably from 1 to 10, p is an integer of from 0 to 5, preferably from 0 to 2, and q is an integer of from 0 to 10, preferably from 1 to 10, provided that o+q is 1 or more, preferably 2 or more.

When the organic compound of the above-described formula is reacted with the silica particles, silyloxy groups (—Si(OR)₃) react with hydroxyl groups on the silica surface and form covalent bonds. Thus, the surface of the silica particles is modified. An ethylenically unsaturated group attached to the silica surface serves as a reaction site with the polymerizable compound.

The surface modification of the silica particles by the above organic compound can be conducted by a technique commonly employed in the art, for example, bringing them into contact for a definite period of time. The modification rate of the silica particle surface ranges usually from 50 to 99%, preferably 80 to 99%. The modification rate of the silica particle surface can be regulated by controlling the mass ratio of the organic compound to the silica particles.

Since the organic compound has at least one ethylenically unsaturated group, the adhesiveness of the image forming layer, which contains the silica particles having been modified with the organic compound and the polymerizable compound, to the undercoat layer can be further improved. Therefore, the lithographic printing plate precursor, which has the image forming layer on the support via the undercoat layer, can sustain favorable unity of the support with the image forming layer even though the polymerizable compound in the image forming layer undergoes crosslinking upon exposure and thus the image forming layer is constricted.

The image forming layer of the lithographic printing plate precursor according to the invention can be obtained by coating a solution, which is prepared by dissolving a photosensitive composition containing the polymerizable compound as described above in organic solvents of various kinds, on the undercoat layer.

Examples of the solvent usable herein include acetone, methyl ethyl ketone, cyclohexane, ethyl acetate, ethylene dichloride, tetrahydrofuran, dimethyl ether, diethyl ether, toluene, ethylene glycol monomethyl ether, ethylene glycol monoethyl ether, ethylene glycol dimethyl ether, propylene glycol monomethyl ether, propylene glycol monoethyl ether, acetyl acetone, cyclohexanone, diacetone alcohol, ethylene glycol monomethyl ether acetate, ethylene glycol ethyl ether acetate, ethylene glycol monoisopropyl ether, ethylene glycol monobutyl ether acetate, 3-methoxypropanol, methoxymethoxyethanol, diethylene glycol monomethyl ether, diethylene glycol monoethyl ether, diethylene glycol dimethyl ether, diethylene glycol diethyl ether, propylene glycol monomethyl ether acetate, propylene glycol monoethyl ether acetate, 3-methoxypropyl acetate, N,N-dimethylformamide, dimethyl sulfoxide, γ-butyrolactone, methyl lactate, ethyl lactate, methanol, ethanol, propanol, butanol, water and so on. Either one of these solvents or a mixture thereof may be used. The concentration of solid matters in the coating solution is appropriately from 1 to 50 mass %.

It is appropriate that the coating amount of the image forming layer in the lithographic printing plate precursor according to the invention ranges from 0.1 to 10 g/m², preferably from 0.3 to 5 g/m2 and more preferably from 0.5 to 3 g/m² in terms of mass after drying.

### [Support]

As the support of the lithographic printing plate precursor according to the invention, any support can be used without limitation, so long as it has hydrophilic surface. A dimensionally stable plate-like material is preferred. Examples of the support include papers, papers laminated with a plastic (for example, polyethylene, polypropylene, polystyrene, etc.), plates of metals (for example, aluminum including aluminum alloys, zinc, copper, etc.) or alloys thereof (for example, alloys with silicon, copper, manganese, magnesium, chromium, zinc, lead, bismuth or nickel), plastic films (for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonates, polyvinyl acetal, etc.), and papers or plastic films having the above-described metal or alloy laminated or vapor deposited thereon. Among these supports, an aluminum plate is particularly preferable because of having an extremely high dimensional stability and being less expensive. Furthermore, a composite sheet having an aluminum sheet coupled on a polyethylene terephthalate film as described in JP-B-48-18327 is also preferable. The thickness thereof usually ranges from about 0.05 mm to about 1 mm.

It is preferable that a support having a metallic (in particular, aluminum) surface has been surface-treated by, for example, the sandblasting as will be described hereinafter, dipping in an aqueous solution of sodium silicate, potassium fluorozirconate, phosphate, etc., or anodic oxidation.

### <Sandblasting>

Examples of the sandblasting treatment include mechanical sandblasting, chemical etching, and electrolytic graining as disclosed in JP-A-56-28893. In addition, use can be made of an electrochemical sandblasting method comprising performing electrochemical sandblasting in a hydrochloric acid or nitric acid electrolytic liquid and a mechanical sandblasting method such as a wire brush graining method comprising scratching the aluminum surface using a metallic wire, a ball graining method comprising sandblasting the aluminum surface using an abrasive ball and an abrasive material, and a brush graining method comprising sandblasting the surface using a nylon brush and an abrasive material. These sandblasting methods can be carried out singly or in combination. Among all, the method to be used for achieving the surface roughness useful in the present invention is an electrochemical method wherein chemical sandblasting is conducted in a hydrochloric acid or nitric acid electrolytic liquid. In this method, the current density is suitably in the range of from 100 to 400 C/dm². More specifically, it is preferable that electrolysis is carried out in an electrolytic liquid containing from 0.1 to 50 mass % of hydrochloric acid or nitric acid under conditions at a temperature of from 20 to 100° C. for a period of time of from 1 second to 30 minutes in a current density of from 100 C/dm² to 400 C/dm².

The thus sandblasted aluminum support is chemically etched with an acid or an alkali. Use of an acid as the etching agent is disadvantageous in industrially carrying out the invention, since it takes a long time to destroy microstructures, However, this problem can be overcome by using an alkali as the etching agent. Examples of an etching agent which is suitably used include caustic soda, sodium carbonate, sodium aluminate, sodium metasilicate, sodium phosphate, potassium hydroxide, lithium hydroxide and so on. Preferred ranges of the concentration and temperature are respectively from 1 to 50 mass % and from 20 to 100° C. It is favorable to employ such conditions as allowing the dissolution of 5 to 20 g/m³ of aluminum.

After the completion of the etching, acid washing is carried out to remove stains (smuts) remaining on the surface. Examples of the acid to be used include nitric acid, sulfuric acid, phosphoric acid, chromic acid, hydrofluoric acid, borofluoric acid, etc. As particularly preferable examples of the desmutting method following the electrochemical surface roughing, there can be enumerated a method which comprises bringing the surface into contact with a 15 to 65 mass % sulfuric acid at a temperature of from 50 to 90° C. as described in JP-A-53-12739 and an alkaline etching method as described in JP-B-48-28123. In the invention, it is preferable that the surface roughness (Ra) of the aluminum support is from 0.3 to 0.7 μm.

### <Anodic Oxidation Treatment>

The thus treated aluminum support is then preferably subjected to an anodic oxidation treatment. The anodic oxidation treatment can be carried out by a method conventionally employed in the art. More specifically speaking, the anodic oxidation treatment is carried out by passing a direct or alternate current in aluminum with the use of an aqueous or non-aqueous solution of sulfuric acid, phosphoric acid, chromic acid, oxalic acid, sulfamic acid, benzenesulfonic acid or a combination of two or more kinds thereof. Thus, an oxidation film can be formed on the surface of the aluminum support. The treatment conditions for the anodic oxidation cannot be determined in general since they widely vary depending on the electrolyte employed. In general, it is appropriate that the concentration of the electrolyte solution ranges from 1 to 80 mass %, the solution temperature ranges from 5 to 70° C., the current density ranges from 0.5 to 60 A/dm², the voltage ranges from 1 to 100 V and the electrolysis time ranges from 10 to 100 seconds.

Among these anodic oxidation treatment methods, it is preferable to use a method of carrying out anodic oxidation in sulfuric acid at a high current density as disclosed in British Patent 1,412,768 and a method of carrying out anodic oxidation with the use of phosphoric acid as an electrolytic bath as disclosed in U.S. Pat. No. 3,511,661.

In the invention, it is preferable that the anodic oxidation film is from 1 to 10 g/m². When it is less than 1 g/m², the plate frequently suffers from cutting and marks. When it exceeds 10 g/m², much electricity is required in the production, which brings about an economical disadvantage. More preferably, the anodic oxidation film is from 1.5 to 7 g/m², more preferably from 2 to 5 g/m².

In the invention, the support may be subjected to a sealing treatment after the completion of the sandblasting and the anodic oxidation. This sealing treatment may be conducted by dipping the substrate in hot water or a hot aqueous solution containing an inorganic salt or an organic salt, using a steam bath or the like.

It is also preferable in the invention to treat the support with an alkali metal silicate after the completion of the sandblasting and the anode oxidation. Owing to this treatment, the adhesiveness between the undercoat layer and the support can be further improved. The treatment with alkali metal silicate as described herein means dipping the support in an aqueous alkali metal silicate solution for a definite period of time. In this alkali metal silicate treatment, the treating time is preferably from 1 second to 2 minutes and the temperature of the aqueous alkali metal silicate solution is preferably from 40 to 90° C., and the concentration of the aqueous alkali metal silicate solution is preferably from 1 g/l to 50 g/l. Examples of the alkali metal silicate include sodium silicate, potassium silicate and lithium silicate.

### [Plate-Making]

It is preferable that the above-described lithographic printing plate precursor as described above is exposed imagewise to laser beams. Although the laser to be used in the invention is not particularly restricted, it is preferable to use a solid laser or a semiconductor laser radiating infrared rays of 760 nm to 1200 nm. The output of the infrared laser is preferably 100 mW or more. To shorten the exposure time, it is also preferable to use a multibeam laser device.

It is preferable that the exposure time per pixel is not longer than 20 μsec. The irradiation energy preferably ranges from 10 to 300 mJ/cm².

As the aqueous component to be used in the invention for removing the image forming layer in an unexposed area, solutions wherein various compounds are dissolved or dispersed in water may be cited. From the viewpoint of on-press developability, it is preferable to use, as the various compounds to be dissolved or dispersed in water, polar solvents such as alcohols, surfactants, organic acids and salts thereof, inorganic acid and salts thereof, etc. The removal can be conducted either on a printing press or by using a development machine.

Examples of the above-described alcohols include methanol, ethanol, propanol, isopropanol, benzyl alcohol, ethylene glycol, ethylene glycol monomethyl ether, 2-ethoxyethanol, diethylene glycol monoethyl ether, diethylene glycol monohexyl ether, triethylene glycol monomethyl ether, propylene glycol, propylene glycol monomethyl ether, propylene glycol monoethyl ether, propylene glycol mono-n-propyl ether, propylene glycol mono-n-butyl ether, dipropylene glycol monomethyl ether, octanediol, polyethylene glycol monomethyl ether, polypropylene glycol, tetraethylene glycol, glycerol and so on.

Among them, it is particularly preferable to use isopropanol, benzyl alcohol, propylene glycol monomethyl ether, propylene glycol mono-n-butyl ether, octanediol or glycerol.

The alcohol content of the aqueous component is preferably from 0.01 to 10 mass %, more preferably from 0.1 to 5 mass % and particularly preferably from 0.5 to 3 mass %. Within this range, the on-press developability can be favorably accelerated without damaging the exposed area of the image forming layer.

In the case of using an aqueous solution containing the above-described surfactant as the aqueous component, it is preferable to select an aqueous component showing little foaming from among the aqueous components exemplified above, from the viewpoint of avoiding various troubles caused by foaming, e.g., foaming between a blanket washing unit and the blanket surface, foaming in a tank for storing the aqueous component, and an increase in the load on a pump due to bubbles invading into a feeding pump for supplying the aqueous component to the blanket washing unit.

As the surfactant, use may be made of nonionic surfactants, anionic surfactants, etc. without specific limitations.

Examples of the nonionic surfactants as described above include higher alcohol ethylene oxide adducts of polyethylene glycol type, alkylphenol ethylene oxide adducts, fatty acid ethylene oxide adducts, polyhydric alcohol fatty acid ester ethylene oxide adducts, higher alkylamine ethylene oxide adducts, fatty acid amide ethylene oxide adducts, ethylene oxide adducts of fats and oils, polypropylene glycol ethylene oxide adducts, dimethylsiloxane-ethylene oxide block copolymers, dimethylsiloxane(propylene oxide-ethylene oxide) block copolymers and the like, fatty acid ester of glycerol of polyhydric alcohol type, fatty acid esters of pentaerythritol, fatty acid esters of sorbitol and sorbitan, fatty acid esters of sucrose, alkyl ethers of polyhydric alcohol, fatty acid amines of alkanolamines, and so on. Either one of these nonionic surfactants or a combination of two or more may be used.

The HLB (Hydrophile-Lipophile Balance) value of the nonionic surfactant is preferably from 6 to 15, more preferably from 6 to 13, most preferably from 6 to 11 from the viewpoints of stable solubility or turbidity in water and improvement of the on-press developability as described above.

Examples of the anionic surfactants as described above include fatty acid salts, abietic acid salts, hydroxyalkanesulfonic acid salts, alkanesulfonic acid salts, dialkylsulfosuccinic acid salts, linear alkylbenzenesulfonic acid salts, branched alkylbenzenesulfonic acid salts, alkylnaphthalenesulfonic acid salts, alkylphenoxypolyoxyethylene propylsulfonic acid salts, polyoxyethylene alkylsulfophenyl ether salts, N-methyl-N-oleyltaurine sodium salts, N-alkylsulfossucinic acid monoamide disodium salts, petroleum sulfonic acid salts, sulfated castor oil, sulfated beef tallow, fatty acid alkyl ester sulfuric acid ester salts, alkylsulfuric acid ester salts, polyoxyethylene alkyl ether sulfuric acid ester salts, fatty acid monoglyceride sulfuric acid ester salts, polyoxyethylene alkylphenyl ether sulfuric acid ester salts, polyoxyethylene styrylphenyl ether sulfuric acid ester salts, alkylphosphoric acid ester salts, polyoxyethylene alkyl ether phosphoric acid ester salts, polyoxyethylene alkylphenyl ether phosphoric acid ester salts, partly saponified styrene/maleic anhydride copolymers, partly saponified olefin/maleic anhydride copolymers, naphthalenesulfonic acid salt/formalin condensates and so on.

Specific examples thereof include sodium dodecylbenzenesulfonate, sodium lauryl sulfate, sodium alkyl diphenyl ether disulfonates, sodium alkylnaphthalenesulfonates, sodium dialkylsulfosuccinates, sodium stearate, potassium oleate, sodium dioctylsulfosuccinate, sodium polyoxyethylene alklyl ether sulfates, sodium polyoxyethylene alkyl phenyl ether sulfates, sodium dialkylsulfosuccinates, sodium stearate, sodium oleate, sodium tert-octylphenoxyethoxypolyethoxyethylsulfates, and so on.

Among these surfactants, it is particularly preferable to use dialkylsulfosuccinates, alkyl sulfate salts and alkyl naphthalenesulfonates.

The ratio of the surfactant contained in the above-described aqueous component is preferably from 0.01 to 0.20 mass %, more preferably from 0.02 to 0.18 mass % and particularly preferably from 0.04 to 0.15 mass %. Within this range, the on-press developability can be favorably accelerated without deteriorating in the stability of the aqueous component or causing problems due to foaming.

To further prevent foaming, it is also possible to add a publicly known defoaming agent to the aqueous component. As the above defoaming agent, a silicone-based defoaming agent is particularly preferred. Moreover, it is also possible to add an alkali agent (for example, sodium carbonate, diethanolamine, sodium hydroxide, etc.) and a preservative (for example, benzoic acid or its derivative, sodium dehydroacetate, a 3-isothiazolone compound, 2-bromo-2-nitro-1,3-propanediol, 2-pyridinethiol-1-oxide sodium salt, etc.) to the above-described aqueous component.

Examples of the water-soluble high molecule compound usable in the aqueous component in the invention include soybean polysaccharides, modified starch, gum arabic, dextrin, cellulose derivatives (for example, carboxymethylcellulose, carboxyethylcellulose, methylcellulose, etc.) and denatured products thereof, pullulan, polyvinyl alcohol and its derivatives, polyvinylpyrrolidone, polyacrylamide and acrylamide copolymers, vinyl methyl ether/maleic anhydride copolymers, vinyl acetate/maleic anhydride copolymers, styrene/maleic anhydride copolymers and so on.

As the soybean polysaccharides as described above, publicly known ones can be used. For example, it is possible to use marketed products SOYA FIVE in various grades(manufactured by Fuji Oil Co., Ltd.). Use can be preferably made of one a 10 mass % aqueous solution of which shows a viscosity falling within the range of 10 to 100 mPa/sec.

As the modified starch as described above, publicly known ones can be also used. These materials can be prepared by, for example, a method which comprises digesting starch of corn, potato, tapioca, rice, wheat or the like to give 5 to 30 glucose residues per molecule with the use of an enzyme, etc., and then adding oxypropylene thereto in an alkali.

It is possible to use two or more kinds of the water-soluble high molecule compounds. The content of the water-soluble high molecule compound in the aqueous component is preferably from 0.1 to 20 mass %, more preferably from 0.5 to 10 mass %.

As the aqueous component containing various additives as discussed above, use can be made of existing fountain solutions of various types.

It is preferable that the aqueous component is supplied on the lithographic printing plate precursor in such a liquid amount as to give a thickness of 0.1 to 5 μm on the lithographic printing plate precursor, more preferably from 0.5 to 3 μm, though the amount depends on the kind of the aqueous component, etc.

Although the aqueous component can be used at an arbitrary temperature, the temperature preferably ranges from 10 to 50° C.

The pH value of the above-described aqueous component is preferably from 2.0 to 10.0, more preferably from 3.0 to 9.0 and most preferably from 3.5 to 8.5.

In the lithographic printing method according to the invention, the lithographic printing plate precursor of the invention may be imagewise exposed to a laser followed by the development and printing, as described above. From the viewpoint of simplifying the process, it is preferred to conduct printing by supplying an oily ink and the aqueous component without resorting to any development step, as will be described in greater detail hereinafter.

More specifically speaking, there can be enumerated a method wherein a lithographic printing plate precursor is exposed to an infrared laser and mounted on a printing press followed by printing without resorting to any development step, a method wherein a lithographic printing plate precursor is mounted on a printing press and then exposed to an infrared laser on the printing press followed by printing without resorting to any development step, and so on.

In the case where a lithographic printing plate precursor is imagewise exposed to an infrared laser and then an aqueous component and an oily ink is supplied followed by printing without resorting to any development step such as a wet development step, the image forming layer having been hardened by the exposure forms an oily ink-receiving area having lipophilic surface in an exposed area of the image forming layer. In an unexposed area, on the other hand, the image forming layer is dissolved or dispersed in the supplied aqueous component and/or oily ink and thus removed. In this area, therefore, the hydrophilic surface comes outward.

As a result, the aqueous component adheres to the hydrophilic surface thus coming outward while the oily ink is impressed into the image forming layer in the exposed area, thereby starting printing. Although either the aqueous component or the oily ink may be supplied first to the printing plate, it is preferred to supply the oily ink first so as to prevent the aqueous component from contamination with the image forming layer in the unexposed area. As the aqueous component and the oily ink, use can be made of a fountain solution and a printing ink commonly employed in lithographic printing.

Thus, the lithographic printing plate precursor is on-press developed on an offset printing press and employed as such for printing of a number of sheets.

### EXAMPLES

Now, the invention will be described in greater detail by referring to the following Examples and Comparative Examples, though it is to be understood that the invention is not restricted thereto.

### Examples 1 to 12 and Comparative Example 1

### 1. Construction of Lithographic Printing Plate Precursor

An aluminum support having been subjected to electrolytic surface-roughing and anodic oxidation with phosphonic acid is preliminarily treated with polyvinylphospholic acid. On this support, a coating solution, which is prepared by dissolving the respective components listed in Table 1 or 2 in a solvent (n-propanol/water2-butanone=76/20/4 by mass) to give a solid concentration of 12%, is wire bar-coated in such an amount as to give a dry coating dose of 1.5 g/m² and then dried at 100° C. for 90 seconds.

TABLE 1
Composition (g) of coating solution for image forming layer
(Examples 1 to 6 and Comparative Example 1)

| Component | | Comp. Ex. 1 | Ex. 1 | Ex. 2 | Ex. 3 | Ex. 4 | Ex. 5 | Ex. 6 |
|---|---|---|---|---|---|---|---|---|
| Urethane acrylate (*1) | | 30.00 | 30.00 | 30.00 | 30.00 | 30.00 | 30.00 | 30.00 |
| Copolymer dispersion (*2) | | 46.25 | 46.25 | 46.25 | 46.25 | 46.25 | 46.25 | 46.25 |
| Trimethylol propane tetraacrylate | | 4.90 | 4.90 | 4.90 | 4.90 | 4.90 | 4.90 | 4.90 |
| (SR399E manufactured by Thertomer, Co., Ltd.) | | | | | | | | |
| Polymethyl methacrylate | | 4.90 | 0 | 0 | 0 | 0 | 0 | 0 |
| Hydroxypropylcellulose | | 1.00 | 1.00 | 1.00 | 1.00 | 1.00 | 1.00 | 1.00 |
| (2 mass % aqueous solution) | | | | | | | | |
| Irgacure 250 (*3) | | 4.69 | 4.69 | 4.69 | 4.69 | 4.69 | 4.69 | 4.69 |
| Mercapto-3-triazole-1H,2,4 | | 2.73 | 2.73 | 2.73 | 2.73 | 2.73 | 2.73 | 2.73 |
| (manufactured by PCAS, France) | | | | | | | | |
| BYK326 (*4) | | 2.23 | 2.23 | 2.23 | 2.23 | 2.23 | 2.23 | 2.23 |
| IR dyestuff of the following structure | | 1.96 | 1.96 | 1.96 | 1.96 | 1.96 | 1.96 | 1.96 |
| Polymer with polar group | Kind | No | (1) | (1) | (1) | (1) | (1) | (2) |
| | Amount | 0 | 2.55 | 5.42 | 12.15 | 16.20 | 20.80 | 12.15 |

TABLE 2
Composition (g) of coating solution for image forming layer
(Examples 7 to 12)

| Component | | Ex. 7 | Ex. 8 | Ex. 9 | Ex. 10 | Ex. 11 | Ex. 12 |
|---|---|---|---|---|---|---|---|
| Urethane acrylate (*1) | | 30.00 | 30.00 | 30.00 | 30.00 | 30.00 | 30.00 |
| Copolymer dispersion (*2) | | 46.25 | 46.25 | 46.25 | 46.25 | 46.25 | 46.25 |
| Trimethylol propane tetraacrylate | | 4.90 | 4.90 | 4.90 | 4.90 | 4.90 | 4.90 |
| (SR399E manufactured by Thertomer, Co., Ltd.) | | | | | | | |
| Polymethyl methacrylate | | 0 | 0 | 0 | 0 | 0 | 0 |
| Hydroxypropylcellulose | | 1.00 | 1.00 | 1.00 | 1.00 | 1.00 | 1.00 |
| (2 mass % aqueous solution) | | | | | | | |
| Irgacure 250 (*3) | | 4.69 | 4.69 | 4.69 | 4.69 | 4.69 | 4.69 |
| Mercapto-3-triazole-1H,2,4 | | 2.73 | 2.73 | 2.73 | 2.73 | 2.73 | 2.73 |
| (manufactured by PCAS, France) | | | | | | | |
| BYK326 (*4) | | 2.23 | 2.23 | 2.23 | 2.23 | 2.23 | 2.23 |
| IR dyestuff of the following structure (*5) | | 1.96 | 1.96 | 1.96 | 1.96 | 1.96 | 1.96 |
| Polymer with polar group | Kind | (4) | (4) | (4) | (4) | (4) | (5) |
| | Amount | 10.80 | 13.90 | 24.30 | 36.85 | 41.60 | 24.30 |

(*1) A 80 mass % solution in 2-butanone of a product obtained by reacting DESMODUR N100 (an aliphatic polyisocyanate resin containing hexamethylene diisocyanate; manufactured by Bayer AG) with hydroxyethyl acrylate and pentaerythritol acrylate.
(*2) A 21 mass % dispersion in a n-propanol/water (80/20) solvent mixture of a polyethylene glycol methyl ether methacrylate/styrene/acrylonitrile (10/20/70) copolymer.
(*3) A 75 mass % solution in propylene carbonate of iodonium (4-methoxyphenyl[4-(2-methylpropyl)phenyl]hexafluorophosphate (manufactured by Ciba Specialty Chemicals, Inc.).
(*4) A 25 mass % solution in xyelene/methoxypropylacetic acid of a denatured dimethyl polysiloxane copolymer (manufactured by BYK Chemie).
(*5) A cationic dyestuff represented by the following chemical formula showing an absorption in the near infrared range.

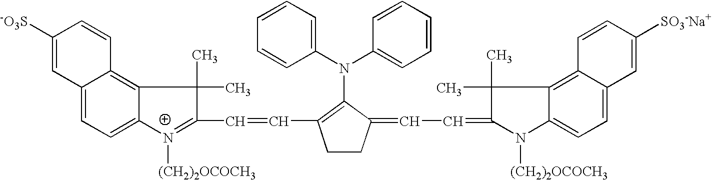

Polymer with polar group (1): poly[vinylbenzyltrimethylammonium chloride-co-N-(3-aminopropyl)methacrylamide hydrochloride] (molar ratio 19:1).

Polymer with polar group (2): poly(N,N,N,N-p-vinylbenzyl(trimethylammoniummethyl)dimethylammonium dichloride-co-N-(3-aminopropyl)methacrylamide hydrochloride] (molar ratio 9:1).

### 2. Evaluation of Lithographic Printing Plate Precursor

The water content change rate W(r) in the exposed area of each lithographic printing plate precursor thus obtained is measured by the method as described above and thus the on-press developability and the printing durability are evaluated.

The lithographic printing plate precursor is exposed by Trendsetter 3244VX (manufactured by Creo Co.) equipped with a water-cooled 40 W infrared semiconductor laser under the conditions of power of 17 W, a rotational number of an outer surface drum of 133 rpm (exposure dose 300 mJ/cm²) and resolution of 2400 dpi.

The exposed plate precursor is not subjected to development but mounted on the cylinder of a printing press Sprint 25 (manufactured by Komori Corporation). After supplying a 4% by volume aqueous solution of a fountain solution IF102 (manufactured by Fuji Photo Film Co., Ltd.) and a black ink TRANS-G(N) (manufactured by Dainippon Ink and Chemicals, Inc.), printing is conducted at a printing speed of 8,000 sheets per hour. The on-press developability is evaluated based on the number of printing paper sheets required until a favorable printing matter is obtained.

After the on-press development, the printing is continued. Then, the image forming layer in the image area abrades away and the ink receptivity is lowered, which results in a decrease in ink density (reflection density). The printing durability is evaluated based on the number of printing paper sheets obtained until the ink density decreases by 0.1 from that at the initiation of printing.

Table 3 summarizes the results of the measurement and evaluation as described above.

TABLE 3
Evaluation results

| | Comp. | | | | | | | | | | Ex. | Ex. | Ex. |
|---|---|---|---|---|---|---|---|---|---|---|---|---|---|
| Component | Ex. 1 | Ex. 1 | Ex. 2 | Ex. 3 | Ex. 4 | Ex. 5 | Ex. 6 | Ex. 7 | Ex. 8 | Ex. 9 | 10 | 11 | 12 |
| Water content change rate | 2.2 | 1.8 | 1.7 | 1.5 | 1.3 | 1.2 | 1.7 | 1.6 | 1.5 | 1.3 | 1.1 | 1.0 | 1.3 |
| W(r) in the exposed area | | | | | | | | | | | | | |
| (mass %) | | | | | | | | | | | | | |
| On-press developability | 18 | 17 | 16 | 16 | 17 | 20 | 16 | 18 | 17 | 14 | 13 | 12 | 14 |
| (sheets) | | | | | | | | | | | | | |
| Printing durability | 1.5 | 1.7 | 1.8 | 2.1 | 2.3 | 2.4 | 1.8 | 1.8 | 1.9 | 2.2 | 1.8 | 1.7 | 2.1 |
| (×10⁴ sheets) | | | | | | | | | | | | | |

As the above results indicate, a high printing durability can be established without damaging on-press developability by regulating the water content change rate W(r) in the exposed area to 2.0 mass % or less.

According to the invention, it is possible to provide a lithographic printing plate precursor which enables image recording by laser exposure and is excellent in on-press developability and printing durability.

The entire disclosure of each and every foreign patent application from which the benefit of foreign priority has been claimed in the present application is incorporated herein by reference, as if fully set forth.

What is claimed is:

1. A lithographic printing plate precursor, which is on-press developable by supplying an oily ink and an aqueous component, comprising:
an image forming layer that has, in an exposed area thereof at 25° C., a water content change rate of 2.0 mass % or less when relative humidity is changed from 30% to 50%.

2. The lithographic printing plate precursor according to claim 1, wherein
the water content change rate is from 0.5 to 1.5 mass %.

3. The lithographic printing plate precursor according to claim 1, wherein
the image forming layer comprises a binder resin having a functional group which becomes hydrophobic upon exposure.

4. The lithographic printing plate precursor according to claim 3, wherein
the binder resin is contained in an amount of from 5 to 30 mass % based on a total solid content of the image forming layer.

5. The lithographic printing plate precursor according to claim 1, wherein
the image forming layer comprises a polymerizable compound having a salt structure.

6. The lithographic printing plate precursor according to claim 5, wherein
the polymerizable compound is contained in an amount of from 10 to 80 mass % based on a total solid content of the image forming layer.

7. The lithographic printing plate precursor according to claim 5, wherein
the polymerizable compound is an amine salt of a sulfonic acid compound.

8. The lithographic printing plate precursor according to claim 1, wherein
the image forming layer comprises a particle which is dispersible in a polar solvent.

9. The lithographic printing plate precursor according to claim 8, wherein
the particle dispersible in a polar solvent is a particle of a copolymer containing acrylonitrile.
